(19) United States
(12) Patent Application Publication
(10) Pub. No.: US 2006/0257529 A1
(43) Pub. Date: Nov. 16, 2006

(54) Yeast compositions and starter cultures

(76) Inventors: Peter Sommer, Frederiksberg (DK); Jan Clair Nielsen, Hundested (DK)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/545,300

(22) PCT Filed: Feb. 4, 2004
(86) PCT No.: PCT/DK04/00078

§ 371 Date: May 26, 2006

Related U.S. Application Data
(60) Provisional application No. 60/447,271, filed on Feb. 14, 2003.

(30) Foreign Application Priority Data
Feb. 11, 2003 (DK) PA 2003 00199

(51) Int. Cl. A23L 1/28

(52) U.S. Cl. 426/62

(57) ABSTRACT

The present invention aims at solving the problem of how to provide a starter culture, including a mixed starter culture, capable of fermenting e.g. grape juice without losing the desirable characteristics of less competitive non-Saccharomyces yeast species early on in the fermentation process. In order to solve this problem there is provided in one aspect of the invention a composition comprising at least one first yeast organism selected from the family of Saccharomycetaceae excluding the genus of Saccharomyces. In another aspect of the invention there is provided a composition comprising at least one first yeast organism selected from the family of Saccharomycetaceae excluding the genus of Saccharomyces and at least one second yeast organism selected from the family of Saccharomycetaceae excluding the genus of Saccharomyces. In a further aspect of the invention there is provided a composition comprising at least one first yeast organism selected from the family of Saccharomycetaceae excluding the genus of Saccharomyces and at least one further yeast organism selected from the genus of Saccharomyces. In yet another aspect of the invention there is provided a composition comprising at least one first yeast organism selected from the family of Saccaromycetaceae excluding the genus of Saccharomyces and at least one second yeast organism selected from the family of Saccharomycetaceae excluding the genus of Saccharomyces and at least one further yeast organism selected from the genus of Saccharomyces.

### TECHNICAL FIELD

The present invention relates to yeast compositions, in particular yeast starter cultures capable of fermenting carbohydrate sources. The compositions can comprise one or more yeast organisms belonging to the family of Saccharomycetaceae, preferably selected from the geni of Torulaspora and/or Kluyveromyces and excluding the genus of Saccharomyces, optionally in combination with one or more yeast organisms belonging to the genus of Saccharomyces. The compositions are preferably freeze dried or spray/fluid bed dried. The invention also pertains to uses of the compositions for fermenting a carbohydrate source and producing an edible or drinkable product.

### BACKGROUND OF THE INVENTION

Grape juice is a very specialised ecosystem wherein only a few yeast species survive and proliferate. Examples of such few yeast species include the wild yeast families Brettanomyces, Debaromyces, Hanseniaspora, Kloeckera, Torulaspora Zygo-Saccharomyces and Kluyveromyces (Bauer & Pretorius: S. Afr. J. Enol. Vitic. Vol. 21, special issue 2000, pp. 27-51). Survival and proliferation may be either desirable or undesirable depending on the yeast species in question. As grape juice is an oxygen limited and acidic environment with a high concentration of carbohydrates, these conditions naturally favour some yeasts species, which will tend to outgrow yeast species having different requirements for optimal growth. In order to obtain a wine quality with a refined aroma and flavour the use of starter cultures that contain a mixture of selected yeast species, may be considered for a person skilled in the art.

One option for a person skilled in the art to obtain a desired ecosystem, which meets the desire of enhancing the growth of those yeast species that have desirable characteristics in terms of aroma and flavour, would be to compile these desirable yeast species that are able to outgrow the less desirable yeast species and let them make up the desired ecosystem. This ecosystem would be further improvable by addition of sulfur dioxide in antimicrobially effective amounts in order to inhibit or suppress the indigenous population of e.g. spoilage microorganisms.

Saccharomyces cerevisiae is capable of carrying out a final ethanol production due to its extreme adaptability to low oxygen concentration and high ethanol concentration, while other yeast species which may occur in combination with S. cerevisiae, only grow in a few days before they are outgrown by S. cerevisiae. Consequently, such other yeast species can only be found in young wine and they do not contribute to the fermentation process for more than a few days. As reported by Hansen et al. (J. Applied Microbiology; 2001, 91, 541-547), non-Saccharomyces yeast species such as Torulaspora delbrueckii and Kluyveromyces thermotolerans are examples of yeast species, whose ability to grow is very sensitive to low oxygen contents of the growth medium. Such species are therefore not capable of participating for a sufficiently long time in a fermentation wherein S. cerevisiae species are also taking part. This implies a limitation of choice of culture to make up the composition of wine starter cultures and this limitation has for long been a serious problem to wine makers wishing to employ mixed yeast starter cultures for wine production. The background for wishing to use mixed yeast starter cultures may be a desire to produce a wine having a more refined aroma or flavour.

It is known by wine makers that by spontaneous alcohol fermentation a more complex wine can often be produced, i.e. a wine with a desired broader spectrum of aroma and flavours than what is routinely achieved by using commercial starter cultures consisting exclusively of S. cerevisiae. However, such a spontaneous fermentation is very difficult to control and the internal competition between indigenous species present in the grape juice unfortunately often results in the dominance of undesired off-flavour producing species.

Thus, while spontaneous fermentations in some cases may be more desirable than fermentations based on S. cerevisiae starter cultures, spontaneous fermentations are difficult to control and therefore wine with different and unknown characteristics from batch to batch result. In order to obtain a better control of the fermentation process many wine makers today rely on industrially produced S. cerevisiae starter cultures, which unfortunately are devoid of those yeast species which are capable of generating other desirable aroma and flavours. Even when such strains are present in combination with S. cerevisiae they are quickly outgrown due to a lesser survival tolerance-towards e.g. low oxygen levels and high ethanol concentrations.

### SUMMARY OF THE INVENTION

The present invention comprises the aim of solving the problem of how to provide a starter culture, including a mixed starter culture, capable of fermenting e.g. grape juice without losing the desirable characteristics of less competitive non-Saccharomyces yeast species that grow vigorously early on in the fermentation process.

In order to solve this problem, the artisans of the present invention have surprisingly provided in one aspect of the invention a starter culture as a composition of cultures comprising at least one first yeast organism selected from the family of Saccharomycetaceae excluding the genus of Saccharomyces.

In a second aspect of the invention there is provided a composition comprising at least one first yeast organism selected from the family of Saccharomycetaceae excluding the genus of Saccharomyces and at least one second yeast organism selected from the family of Saccharomycetaceae excluding the genus of Saccharomyces.

In a third aspect of the invention there is provided a composition comprising at least one first yeast organism selected from the family of Saccharomycetaceae excluding the genus of Saccharomyces and at least one further yeast organism selected from the genus of Saccharomyces.

In a fourth aspect of the invention there is provided a composition comprising at least one first yeast organism selected from the family of Saccharomycetaceae excluding the genus of Saccharomyces and at least one second yeast organism selected from the family of Saccharomycetaceae excluding the genus of Saccharomyces and at least one further yeast organism selected from the genus of Saccharomyces.

The invention also pertains to methods for preparing the above compositions as well as to methods for their use, including the use of the compositions as starter cultures for the fermentation of a carbohydrate source during e.g. wine making.

Accordingly, in yet further aspects of the invention there is provided:

A method for fermenting at least one fermentable carbohydrate source in an aqueous composition, said method comprising the step of contacting the aqueous composition with the composition according to the invention under conditions allowing said fermentation to occur.

A method for producing an edible or drinkable product, said method comprising the step of adding the composition according to the invention to a precursor composition of said product, fermenting said precursor composition and producing said edible or drinkable product.

A method for flavouring an edible or drinkable product, said method comprising the step of adding the composition according to the invention to a precursor composition of said product, fermenting said precursor composition and flavouring said edible or drinkable product.

A method for preparing a dried composition according to the invention, said method comprising the steps of i) providing at least one first yeast organism, and ii) drying said at least one first yeast organism to produce a dried composition thereof.

A method for preparing a dried composition according to the invention, said method comprising the steps of i) providing at least one first yeast organism selected from the genus of Torulaspora or the genus of Kluyveromyces, and ii) drying said composition.

A method for preparing a dried composition according to the invention, said method comprising the steps of i) providing a composition comprising at least one first yeast organism selected from the genus of Torulaspora and at least one second yeast species selected from the genus of Kluyveromyces, and ii) drying said composition.

A method for preparing a dried composition according to the invention, said method comprising the steps of i) providing a composition comprising at least one first yeast organism selected from the genus of Torulaspora or the genus of Kluyveromyces, and at least one further yeast organism selected from the genus of Saccharomyces, and ii) drying said composition.

A method for preparing a dried composition according to the invention, said method comprising the steps of i) providing at least one first yeast organism selected from the genus of Torulaspora and at least one second yeast organism selected from the genus of Kluyveromyces and at least one further yeast organism selected from the genus of Saccharomyces, and ii) drying said composition.

Use of a composition according to the invention for the manufacture of a yeast starter culture for fermenting grape juice.

Use of a composition according to the invention for producing an edible or drinkable product.

Use of a composition according to the invention for flavouring an edible or drinkable product.

Use of at least one first yeast organism selected from the family of Saccharomycetaceae excluding the genus of Saccharomyces for the preparation of a yeast starter culture for fermenting grape juice and flavouring an edible or drinkable product resuiting from said fermentation.

Use of a composition comprising at least one first yeast organism selected from the family of Saccharomycetaceae excluding the genus of Saccharomyces and at least one second yeast organism selected from the family of Saccharomycetaceae excluding the genus of Saccharomyces for the preparation of a yeast starter culture for fermenting grape juice and flavouring an edible or drinkable product resulting from said fermentation.

Use of a composition comprising at least one first yeast organism selected from the family of Saccharomycetaceae excluding the genus of Saccharomyces and at least one further yeast organism selected from the genus of Saccharomyces for the preparation of a yeast starter culture for fermenting grape juice and flavouring an edible or drinkable product resulting from said fermentation.

Use of a composition comprising at least one first yeast organism selected from the family of Saccharomycetaceae excluding the genus of Saccharomyces and at least one second yeast organism selected from the family of Saccharomycetaceae excluding the genus of Saccharomyces and at least one further yeast organism selected from the genus of Saccharomyces for the preparation of a yeast starter culture for fermenting grape juice and flavouring an edible or drinkable product resulting from said fermentation.

Definitions

Starter culture: If not specifically defined otherwise, starter cultures are a yeast culture, which has been prepared for initiation of a fermentation and/or a conversion of edible or drinkable products.

Yeast organism: Any genus belonging to the family of Saccharomycetaceae. Examples include, but are not limited to: Saccharomyces, Kluyveromyces, Torulaspora, Arxiozyma, Citeromyces, Debaryomyces, Dekkera, Holleya, Issatchenkia, Kazachstania, Kodameae, Lodderomyces, Pachysolen, Pichia, Satumispora, Starmera, Tetrapisispora, Williopsis, Zygosaccharomyces, Breftanomyces, Kloeckera, Candida and Hanseniaspora.

Saccharomyces: Genus belonging to the family of Saccharomycetaceae. The genus of Saccharomyces can be characterised by e.g. rapid growing colinies which are flat, smooth, glistening or dull, and cream to tannish cream in color. Pseudohyphae may be present; and when present, pseudohyphae are rudimentary. Hyphae are absent. Blastoconidia are 1-celled, globose, and ellipsoid to elongate. Asci contain 1 to 4 ascospores, and do not rupture at maturity. Ascospores often are globose. Nitrate is not utilized. The skilled artisan will be able to determine if a given yeast belongs to the genus of Saccharomyces, including Saccharomyces cerevisiae, by using standard references such as e.g. Kurtzman, C. P. and J. W. Fell (editors). 1998. The yeasts, a taxonomic study. 4th ed., Elsevier, N.Y.

Saccharomyces species: A much preferred species is Saccharomyces cerevisiae, optionally in isolated form. Additionally preferred species includes, but is not limited to: Saccharomyces bamettii, Saccharomyces bayanus, Saccharomyces castellii, Saccharomyces dairenensis, Saccharomyces exiguus, Saccharomyces kluyveri, Saccharomyces paradoxus, Saccharomyces pastorianus, Saccharomyces rosinii, Saccharomyces servazzii, Saccharomyces spencerorum, Saccharomyces transvaalensis, and Saccharomyces unisporus. Saccharomyces cerevisiae deposited with the CBS under accession number CBS 1171 is claimed in connection with the present invention.

Saccharomyces cerevisiae synonyms: The following species are listed with the CBS database as synonyms of Saccharomyces cerevisiae: Candida robusta; Cryptococcus fermentans; Hormiscium cerevisiae; Mycotorula robusta; Saccharomyces aceti; Saccharomyces acidosaccharophillii; Saccharomyces anamensis; Saccharomyces annulatus; Saccharomyces batatae; Saccharomyces beticus; Saccharomyces boulardii; Saccharomyces brasiliensis; Saccharomyces busae asiaticae; Saccharomyces capensis; Saccharomyces carbalali; Saccharomyces carlsbergensis; Saccharomyces carlsbergensis var. alcoholophilus; Saccharomyces carlsbergensis var. manchuricus; Saccharomyces cerevisiae Meyen ex E.C. Hansen var. cerevisiae; Saccharomyces cerevisiae f. pini Saccharomyces cerevisiae subsp. orsati; Saccharomyces cerevisiae subsp. vetrozensis; Saccharomyces cerevisiae var. cratericus; Saccharomyces cerevisiae var. ellipsoideus; Saccharomyces cerevisiae var. fructuum; Saccharomyces cerevisiae var. marchalianus; Saccharomyces cerevisiae var. onychophilus; Saccharomyces cerevisiae var. pelliculosus; Saccharomyces cerevisiae var. pulmonalis; Saccharomyces cerevisiae var. turbidans; Saccharomyces cerevisiae agavica sylvestre; Saccharomyces chevalieri var. chevalieri; Saccharomyces chevalieri var. lindneri; Saccharomyces chodati; Saccharomyces chodati; Saccharomyces cordubensis; Saccharomyces coreanus; Saccharomyces diastaticus; Saccharomyces ellipsoideus subsp. alpestris; Saccharomyces ellipsoideus subsp. alpinus; Saccharomyces ellipsoideus subsp. fulliensis; Saccharomyces ellipsoideus subsp. montibensis; Saccharomyces ellipsoideus subsp. thermophilus; Saccharomyces ellipsoideus var. ellipsoideus; Saccharomyces ellipsoideus var. major; Saccharomyces ellipsoideus var. umbra; Saccharomyces elongatus; Saccharomyces eryobotryae; Saccharomyces formosensis; Saccharomyces fructuum; Saccharomyces gaditensis; Saccharomyces hienipiensis; Saccharomyces hispalensis; Saccharomyces hispanica; Saccharomyces hutensis; Saccharomyces ilicis; Saccharomyces italicus var. italicus; Saccharomyces italicus var. melibiosi; Saccharomyces lindneri; Saccharomyces logos; Saccharomyces mangini var. casei; Saccharomyces mangini var. mangini; Saccharomyces mangini var. miso; Saccharomyces marchalianus; Saccharomyces melibiosi; Saccharomyces muentzii; Saccharomyces multisporus; Saccharomyces norbensis; Saccharomyces nutensis; Saccharomyces odessa; Saccharomyces oleaceus; Saccharomyces oleaginosus; Saccharomyces onubensis; Saccharomyces oviformis var. bisporus; Saccharomyces oviformis var. cheriensis; Saccharomyces oviformis var. oviformis; Saccharomyces oxidans; Saccharomyces pastorianus subsp. arbignensis; Saccharomyces peka; Saccharomyces prostoserdovii; Saccharomyces pulmonalis; Saccharomyces robustus; Saccharomyces shaoshing; Saccharomyces steineri; Saccharomyces thermantitonum; Saccharomyces tokyo; Saccharomyces turbidans; Saccharomyces valesiacus; Saccharomyces veronae var. osloensis; Saccharomyces vordermanii; Saccharomyces wildiersil; Saccharomyces willianus; Saccharomyces yedo; Torula cerevisiae; Torulopsis fermentans; and Torulopsis sexta. Accordingly, the above species are also comprised by the term Saccharomyces cerevisiae as used herein. The list is non-limiting and does not exclude that further strains shall be considered synonyms of Saccharomyces cerevisiae.

Non-Saccharomyces: As used herein any of the geni belonging to the family of Saccharomycetaceae excluding the genus of Saccharomyces. Preferred examples include, but is not limited to: Kluyveromyces, Torulaspora, Arxiozyma, Citeromyces, Debaryomyces, Dekkera, Holleya, Issatchenkia, Kazachstania, Kodameae, Lodderomyces, Pachysolen, Pichia, Saturnispora, Starmera, Tetrapisispora, Williopsis, and Zygosaccharomyces.

Torulaspora species: A much preferred species is Torulaspora delbrueckii, optionally in isolated form. Additionally preferred species include, but is not limited to: T. alkoholi var alkoholi, T. alkoholi var. azymatica, T. amurcae, T. bailii, T. benedictae, T. bispora, T. californica, T. carsonii, T. castelli, T. cidri, T. coudertii, T. etchellsii, T. eupagyca, T. exigua, T. fermentati, T. florentina, T. formicaria, T. fransiscae, T. globosa, T. hansenii, T. inconspicua, T. kloeckeriana, T. kluyveri, T. lactis a, T. manchuriana, T. melissophila, T. microellipsoides, T. mongolica, T. montana, T. mrakii, T. nilssonii, T. phaffli, T. polymorpha, T. pretoriensis, T. pseudopolymorpha, T. rosei, T. rouxii, T. tamarii, T. vafer, T. vanrijiae, and T. yarrowii. The following Torulaspora organisms are claimed in connection with the present invention: Torulaspora delbrueckii CBS 1090, CBS 1146, CBS 1148, CBS 1150, CBS 1151, CBS 1152, CBS 1323, CBS 1324, CBS 133, CBS 158, CBS 2733, CBS 2924, CBS CBS 2925, CBS 3003, CBS 3018, CBS 3085, CBS 404, CBS 4510, CBS 4662, CBS 4663, CBS 4664, CBS 4665, CBS 4865, CBS 5448, CBS 5636, CBS 5694, CBS 6104, CBS 6105, CBS 6105.2, CBS 6339, CBS 6518, CBS 6749, CBS 6795, CBS 6871, CBS 6991, CBS 705, CBS 728, CBS 7443, CBS 813, CBS 816, CBS 817, CBS 818, CBS 8247. In one preferred embodiment of the invention, T. delbrueckii CBS 3085 is preferred. The genus of Torulaspora, including the species of Torulaspora delbrueckii, can be characterised by e.g. rapid growing colonies which are round to oval, smooth, and white to cream in color. No hyphae are absent. Asexual reproduction is by budding. Asci contain 1 to 4 ascospores. Ascospores often are often oval and rough. Conjugation occurs between cells and between a cell and its bud. The skilled artisan will be able to determine if a given yeast belongs to the genus of Torulaspora, including Torulaspora delbrueckii, by using standard references such as e.g. Kurtzman, C. P. and J. W. Fell (editors). 1998. The yeasts, a taxonomic study. 4th ed., Elsevier, N.Y.

Torulaspora delbrueckii synonyms: The following species are listed with the CBS database as synonyms of Torulaspora delbrueckii: Candida colliculosa; Cryptococcus colliculosus; Debaryomyces dekkerae; Debaryomyces delbrueckii; Debaryomyces nilssonii; Debaryomyces rosei; Eutorula colliculosa; Saccharomyces chevalieri var. torulosus; Saccharomyces delbrueckii var. delbrueckii; Saccharomyces delbrueckii var. mongolicus; Saccharomyces fermentati; Saccharomyces florenzanoi; Saccharomyces inconspicuus; Saccharomyces microellipsoides var. osmophilus; Saccharomyces nilssonii var. nilssonii; Saccharomyces rosei; Saccharomyces saitoanus; Saccharomyces torulosus; Saccharomyces uvarum var. inulyticus; Saccharomyces vafer; Schwanniomyces hominis; Torula colliculosa; Torulaspora benedictae; Torulaspora fermentati; Torulaspora inconspicua; Torulaspora mongolica; Torulaspora nilssonii; Torulaspora rosei; Torulaspora vafer; Torulopsis cambresieri; Torulopsis colliculosa; Torulopsis stellata var. cambresieri; Torulopsis taboadae; Zygosaccharomyces delbrueckii; Zygosaccharomyces fermentati; Zygosaccharomyces globiformis; Zygosaccharomyces globiformis f. coronata; Zygosaccharomyces globiformis f. typica; Zygosaccharomyces mongolicus; Zymodebaryomyces dekkerae; Zymodebaryomyces delbrueckii; and Zymodebaryomyces rosei. Accordingly, the above species are also comprised by the term Torulaspora delbrueckii as used herein. The list is non-limiting and does not exclude that further strains shall be considered synonyms of Torulaspora delbrueckii.

Kluyveromyces species: A much preferred species is Kluyveromyces thermotolerans, optionally in isolated form. Additionally preferred species include, but is not limited to: K. subgenus Flabospora, K. subgenus Globospora, K. aestuafil, K. africanus, K. bacillisporus, K. blattae, K. bulgaricus, K. cellobiovorus, K. delphensis, K. dobzhanskii, K. drosophilarum, K. fragilis, K. lactis var, drosophilarum, K. lactis var. lactis, K. lodderae, K. marxianus var. bulgaricus, K. marxianus var. dobzhanskii, K. marxianus var. drosophilarum, K. marxianus var. lactis, K. marxianus var. marxianus, K. marxianus var. vanudenii, K. marxianus var. wikenii, K. nonfermentans, K. osmophilus, K. penaeid, K. phaffli, K. phaeseolosporus, K. piceae, K. polysporus, K. sinensis, K. vanudenil, K. veronae, K. waltii, K. wickerhamii, K. wikenii, K. yarrowii. The following Kluyveromyces organisms identified by database accession number are hereby claimed in accordance with the present invention: Kluyveromyces thermotolerans CBS 2803 (also available under ATCC 24177; DBVPG 6166;IFO 1674;NCYC 701;NRRL Y-2232;UCD 55-41;VKM Y-533); CBS 7220, CBS 6925, CBS 6433, CBS 4836, CBS 4835, CBS 4834, CBS 4833, CBS 4832. In one preferred embodiment Kluyveromyces themotolerans CBS 7220 is preferred. The genus of Kluyveromyces, including the species of Kluyveromyces thermotolerans, can be characterised by e.g. rapid growing colonies which are round to oval, smooth, and cream in color. Pseudohyphae may be absent. Asexual reproduction is by budding. Asci contain 1 to 4 ascospores. Ascospores often are oval. Conjugation may occur between cells and between a cell and its bud. The skilled artisan will be able to determine if a given yeast belongs to the genus of Kluyveromyces, including Kluyveromyces thermotolerans, by using standard references such as e.g. Kurtzman, C. P. and J. W. Fell (editors). 1998. The yeasts, a taxonomic study. 4th ed., Elsevier, N.Y.

Kluyveromyces thermotolerans synonyms: The following species are listed with the CBS database as synonyms of Kluyveromyces thermotolerans: Kluyveromyces Van der Walt, Kluyveromyces veronae; Kluyveromyces subgenus Fabospora; Candida dattila; Cryptococcus dattilus; Mycotorula dattila; Saccharomyces drosophilae; Saccharomyces thermotolerans; Saccharomyces veronae var. veronae; Zygosaccharomyces drosophilae; Zygosaccharomyces thermotolerans; Torula dattila; Torulopsis dattila var. dattila; Dekkeromyces sp.; Fabospora sp.; Zygofabospora thermotolerans; and Zygorenospora sp. Accordingly, the above species are also comprised by the term Kluyveromyces thermotolerans as used herein. The list is non-limiting and does not exclude that further strains shall be considered synonyms of Kluyveromyces thermotolerans.

Yeast starter culture: Culture comprising at least one yeast species in liquid culture, liquid pressed culture, frozen form or dried form, including freeze dried form and spray/fluid bed dried form. The culture can be packed in vacuum, or under a protected atmosphere such as e.g. nitrogen and the like. The culture is capable of initiating an industrial fermentation process under practical conditions, optionally after being cultivated in a separate starter medium for obtaining a high density culture. The culture can be added to a fermentable carbohydrate source such as e.g. grape juice once or more times during a fermentation process, and it can be added initially and/or later in the fermentation process.

Mixed yeast starter culture: Yeast starter culture comprising at least one yeast species selected from the genus of Saccharomyces and at least one yeast species selected from the family of Saccharomycetaceae excluding the genus of Saccharomyces.

Taxonomic determinations: The skilled artisan has at his disposal several tools for determining which family, genus and species any particular yeast organism belongs to. For example, recent developments in molecular biology and protein chemistry have provided methods such as DNA restriction fragment length polymorphisms, protein electrophoresis patterns and chromosome fingerprinting. Such techniques have been used for identifying e.g. fermentation-related microorganisms. See, for example, Casey et al., Journal of the American Society of Brewing Chemists, 48(3): 100-106, 1990; Degre et al., American Journal of Enology and Viticulture, 40(4):309-315, 1989; Guillamon et al., Systematic and Applied Microbiology, 19:122-132, 1992; Hoeben et al., Current Genetics, 10:371-379, 1986, Mozina et al., Letters in Applied Microbiology, 24(4):311-315, 1997; Paffetti et al., Research Microbiology, 146:587-594, 1995; Panchal et al., Journal of the Institute of Brewing, 93:325-327, 1987; Querol et al., Systematic and Applied Microbiology, 15:439-446, 1992, Vezinhet et al., Applied Microbiology and Biotechnology, 32:568-571, 1990, and Vezinhet et al., American Journal of Enology and Viticulture, 43(1):83-86, 1992. Polymerase chain reaction (PCR)-based techniques have also been used to detect fermentation-related microorganisms. See, for example, DeBarros Lopes et al., Applied and Environmental Microbiology, 62(12):4514-4520, 1996; Fell, Molecular Marine Biology and Biotechnology, 2(3): 174-180, 1993; Fell, Journal of Industrial Microbiology, 14(6):475-477, 1995; Ibeas et al., Applied and Environmental Microbiology, 62(3):998-1003, 1996; Lavallee et al., American Journal of Enology and Viticulture, 45(1):86-91, 1994; Lieckfeldt et al., Journal of Basic Microbiology, 33(6):413-425, 1993, and Ness et al., J Sci. Food Agric., 62:89-94, 1993. In a different approach, ribosomal genes have been used as molecular probe targets because of their high copy number. Non-transcribed and transcribed spacer sequences associated with ribosomal genes are usually poorly conserved and, thus, are advantageously used as target sequences for the detection of recent evolutionary divergence. Fungral rRNA genes are organized in units. Each unit encodes mature subunits of 18S, 5.8S, and 28S rRNA. The internal transcribed spacer (ITS) region lies between the 18S and 28S rRNA genes and contains two variable non-coding spacers (referred to as ITS1 and ITS2) and the 5.8S rRNA gene (White et al., 1990; In: PCR Protocols; Eds.: Innes et al pages 315-322). In addition, the transcriptional units are separated by non-transcribed spacer sequences (NTSs). The ITS and NTS sequences are particularly suitable molecular probe targets.

### FIGURES

The following figures illustrate the basic physiological properties of Saccharomyces cerevisiae, Torulaspora delbrueckii and Kluyveromyces thermotolerans, as single strains and mixtures thereof, when used as starter cultures for conversion of grape juice, exemplified but not limited to the grape varieties Pinot noir and Chardonnay. The figures illustrate the physiological limitations of Torulaspora delbrueckii and Kluyveromyces thermotolerans when used as pure strains, in their ability to convert the grape juice into wine, and the surprising disclosure of this invention when using mixed yeast starter cultures of Saccharomyces cerevisiae and Torulaspora delbrueckii or Saccharomyces cerevisiae and Kluyveromyces thermotolerans, or any other combinations thereof.

Below are provided two different non-limiting examples of grape juice, each one representing an ecosystem, which is subjected to a fermentation according to the invention.

Pinot noir grape juice has been selected as one example, but not limited to, that is subjected to red wine fermentation conditions according to the invention.

Chardonnay grape juice has been selected as another example, but not limited to, that is subjected to white wine fermentation conditions according to the invention.

The figures have been ordered as follows below:

Pure yeast strain fermentations.

Pinot noir grape juice (experimental series I)

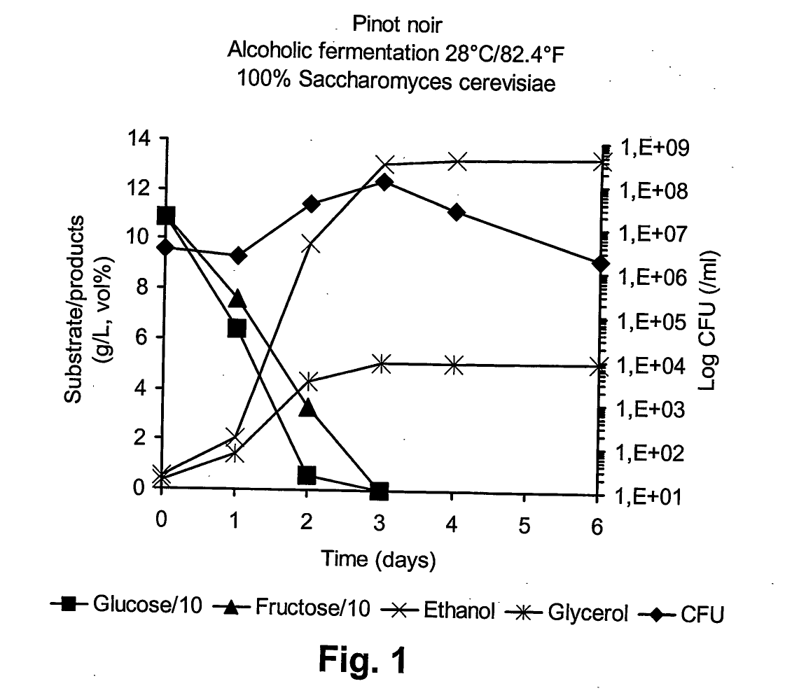

I. 1 Saccharomyces cerevisiae (FIG. 1)

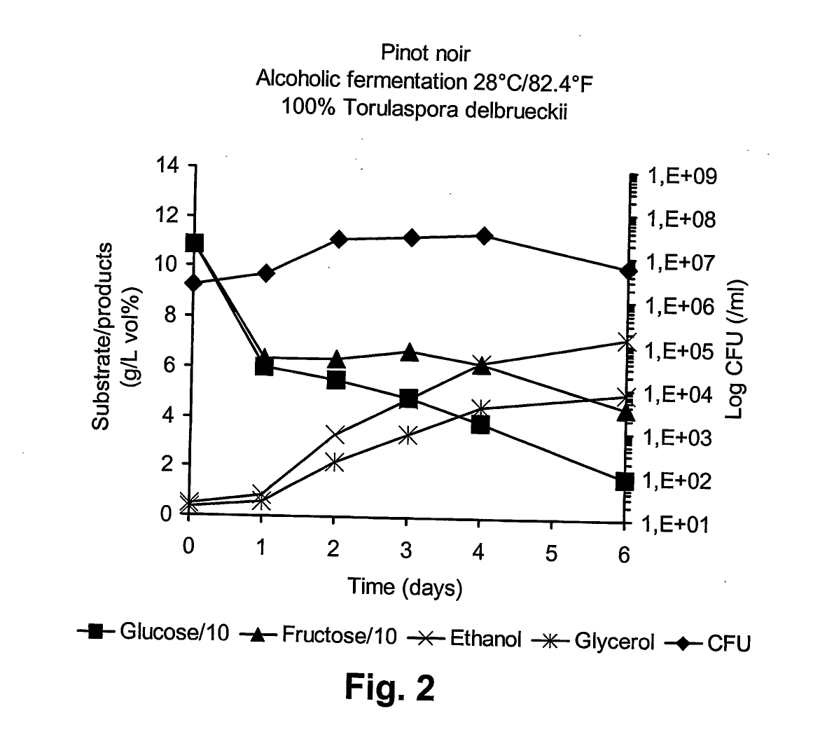

I. 2 Torulaspora delbrueckii (FIG. 2)

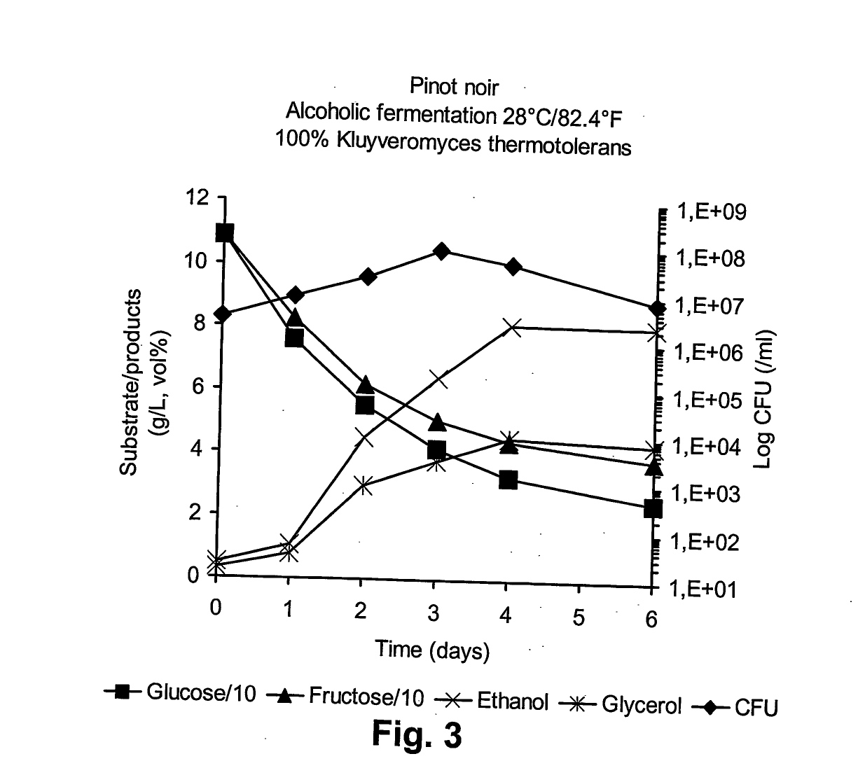

I. 3 Kluyveromyces thermotolerans (FIG. 3)

Chardonnay grape juice (experimental series II)

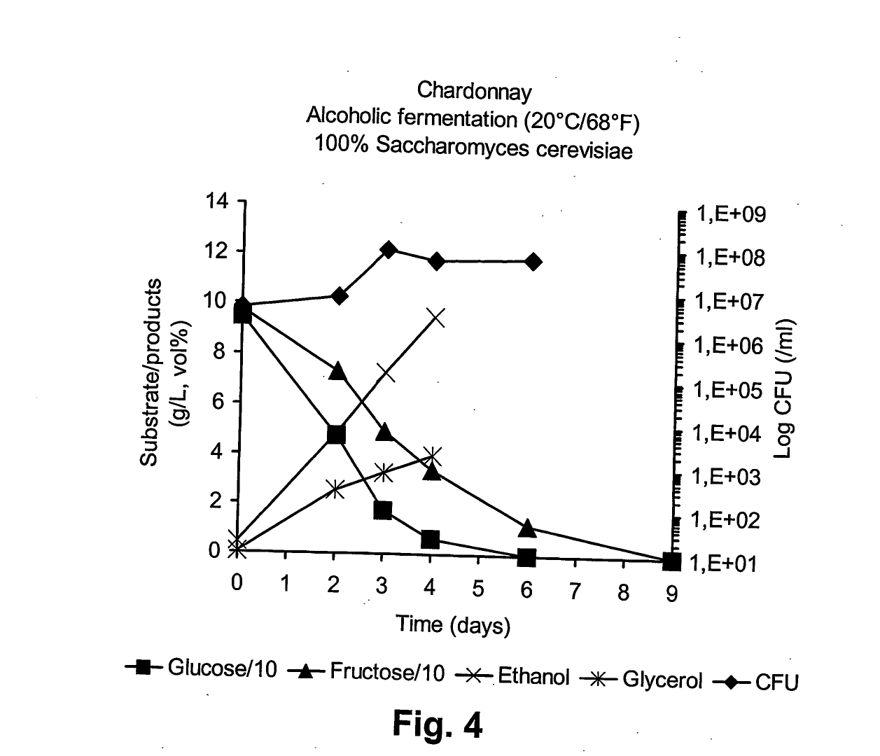

II. 1 Saccharomyces cerevisiae (FIG. 4)

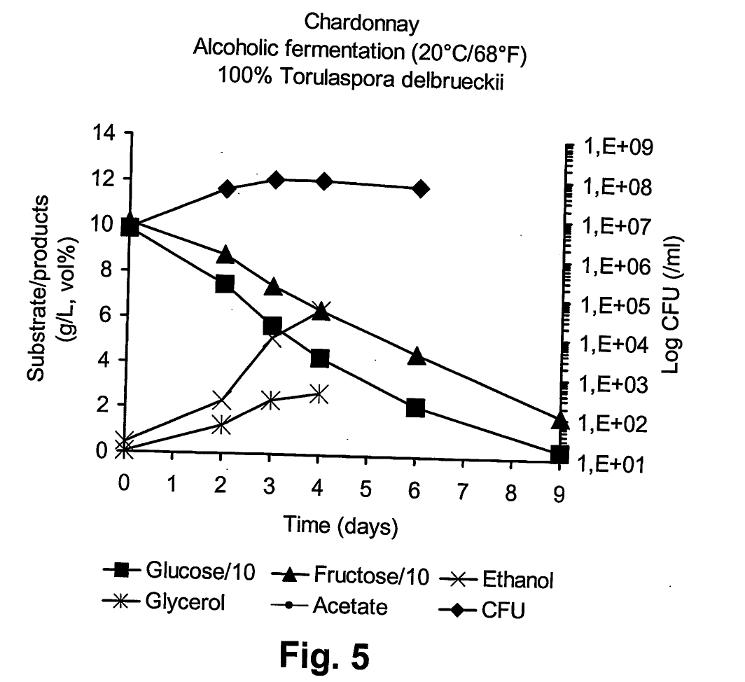

II. 2 Torulaspora delbrueckii (FIG. 5)

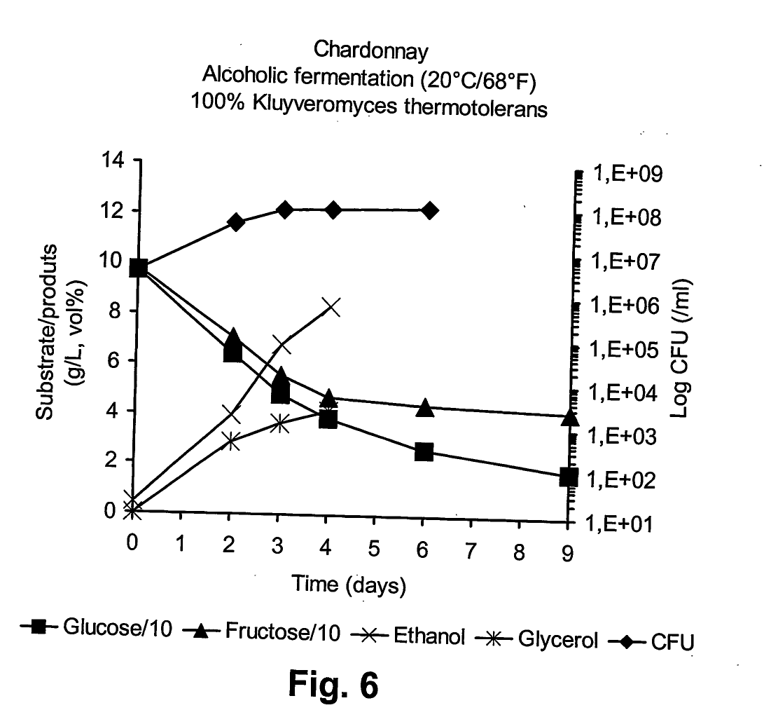

II. 3 Kluyveromyces thermotolerans (FIG. 6)

Mixed yeast strain fermentation

Pinot noir grape juice (experimental series III)

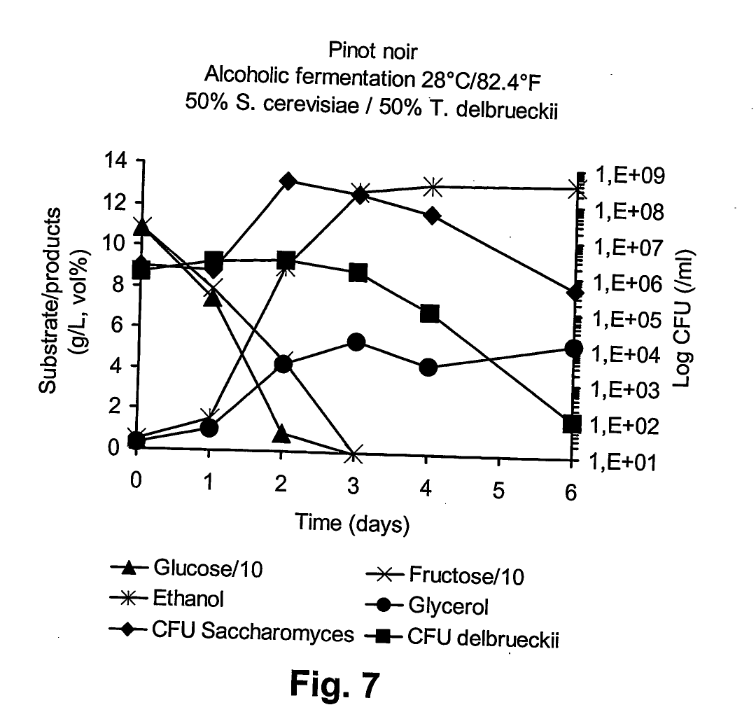

III. 1 Saccharomyces cerevisiae/Torulaspora delbrueckii (FIG. 7)

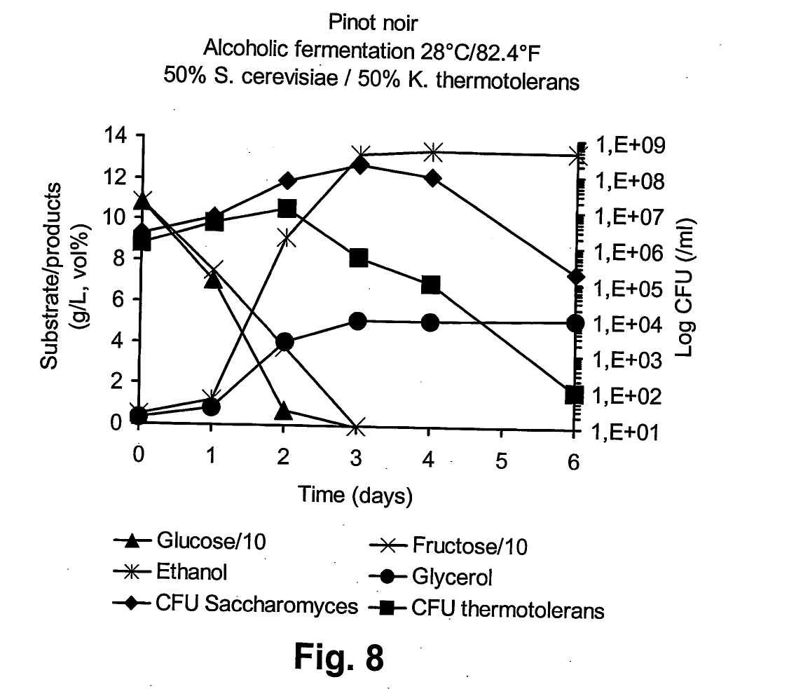

III. 2 Saccharomyces cerevisiae/Kluyveromyces thermotolerans (FIG. 8)

Chardonnay grape juice (experimental series IV)

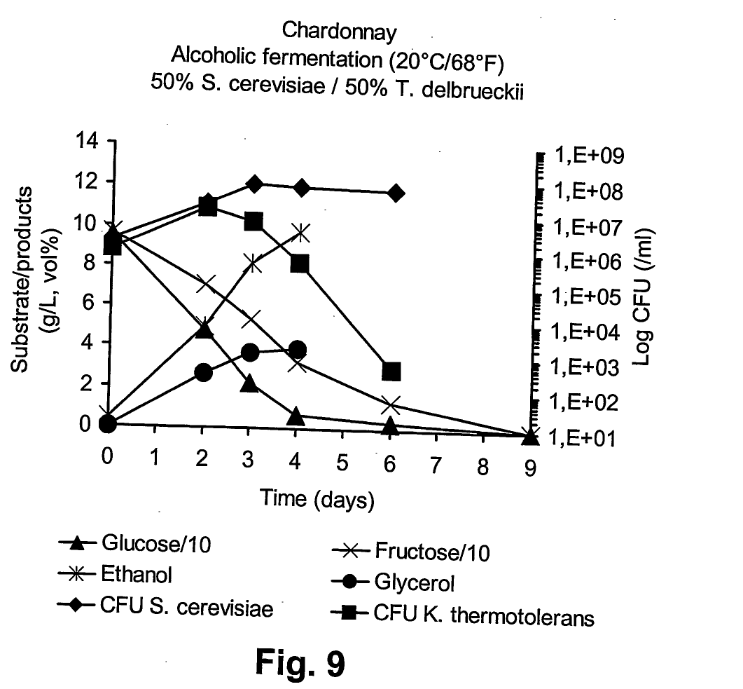

IV. 1 Saccharomyces cerevisiae/Torulaspora delbrueckii (FIG. 9)

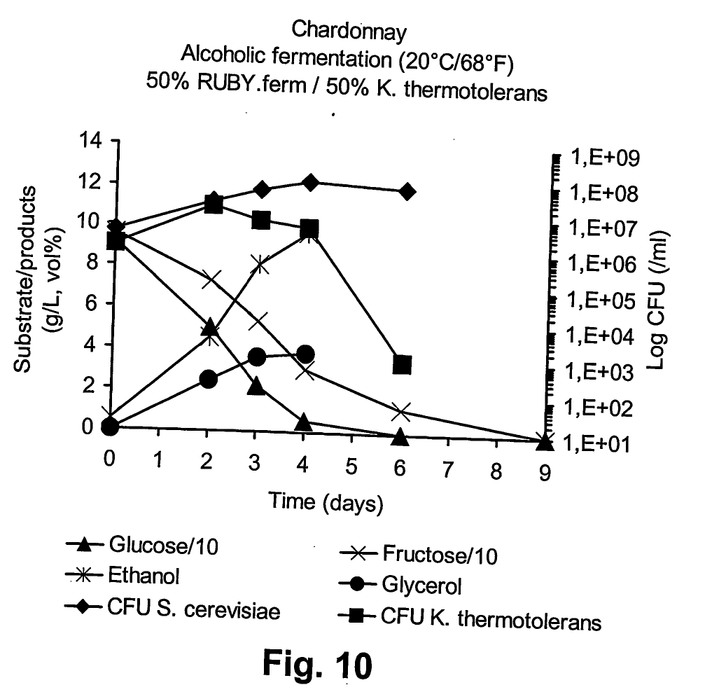

IV. 2 Saccharomyces cerevisiae/Kluyveromyces thermotolerans (FIG. 10)

### EXPERIMENTAL SERIES I

FIG. 1 illustrates a pure strain alcoholic fermentation by Saccharomyces cerevisiae in a Pinot noir grape juice (pasteurised at 140° C./284° F. in 8 seconds and stored in 5 litre sterile plastic containers at 5° C./39.2° F. until use) as a laboratory experiment in 3 litre scale incubated at 28° C./82.4° F. S. cerevisiae was prepared by fluid bed drying as generally known in the art and such as detailed in Example 2 below and re-hydrated as generally known in the art and such as detailed in Example 3 below.

The figure shows that Saccharomyces cerevisiae is able, as a pure culture, to convert glucose and fructose into ethanol and glycerol in only 3 days. The development of CO₂ and acetic acid are not shown. After a minor lag phase, a rapid exponential growth was seen before the cell number decreased significantly at the depletion of the carbohydrates.

FIG. 2 illustrates a pure strain alcoholic fermentation by Torulaspora delbrueckii in a Pinot noir grape juice (pasteurised at 140° C./284° F. in 8 seconds and stored in 5 litre sterile plastic containers at 5° C./39.2° F. until use) in a laboratory experiment in 3 litre scale incubated at 28° C./82.4° F. Torulaspora delbrueckii was prepared by fluid bed drying as generally known in the art and such as detailed in Example 2 below and re-hydrated as generally known in the art and such as detailed in Example 3 below.

T. delbrueckii as a pure culture was not able to convert all the available glucose and fructose and therefore did not complete the alcoholic fermentation during the experiment. The cells only sustained growth for 2 days, before entering the stationary growth phase.

FIG. 3 illustrates a pure strain alcoholic fermentation by Kluyveromyces thermotolerans in a Pinot noir grape juice (pasteurised at 140° C./284° F. in 8 seconds and stored in 5 litre sterile plastic containers at 5° C./39.2° F. until use) in a laboratory experiment in 3 litre scale incubated at 28° C./82.4° F. Kluyveromyces thermotolerans was prepared by fluid bed drying as generally known in the art and such as detailed in Example 2 below and re-hydrated as generally known in the art and such as detailed in Example 3 below.

K. thermotolerans as a pure culture was not able to convert all the available glucose and fructose and therefore did not complete the alcoholic fermentation during the experiment. The cells sustained growth for 3 days, whereafter the cell number decreased significantly.

### EXPERIMENTAL SERIES II

FIG. 4 illustrates a pure strain alcoholic fermentation by Saccharomyces cerevisiae in a Chardonnay grape juice (pasteurised at 140° C./284° F. in 8 seconds and stored in 5 litre sterile plastic containers at 5° C./39.2° F. until use) as a laboratory experiment in 1 litre scale incubated at 20° C./68° F. S. cerevisiae was prepared by fluid bed drying as generally known in the art and such as detailed in Example 2 below and re-hydrated as generally known in the art and such as detailed in Example 3 below.

The figure shows that Saccharomyces cerevisiae is able, as a pure culture, to convert glucose and fructose into ethanol and glycerol in 9 days. The development of CO₂ and acetic acid are not shown.

FIG. 5 illustrates a pure strain alcoholic fermentation by Torulaspora delbrueckii in Chardonnay grape juice (pasteurised at 140° C./284° F. in 8 seconds and stored in 5 litre sterile plastic containers at 5° C./39.2° F. until use) in a laboratory experiment in 1 litre scale incubated at 20° C./68° F. Torulaspora delbrueckii was prepared by fluid bed drying as generally known in the art and such as detailed in Example 2 below and re-hydrated as generally known in the art and such as detailed in Example 3 below.

T. delbrueckii as a pure culture did not complete the alcoholic fermentation during the experiment. The cells grew exponentially for 2 days, before entering the stationary growth phase.

FIG. 6 illustrates a pure strain alcoholic fermentation by Kluyveromyces thermotolerans in a Chardonnay juice (pasteurised at 140° C./284° F. in 8 seconds and stored in 5 litre sterile plastic containers at 5° C./39.2° F. until use) in a laboratory experiment in 1 litre scale incubated at 20° C./68° F. Kluyveromyces thermotolerans was prepared by fluid bed drying as generally known in the art and such as detailed in Example 2 below and rehydrated as generally known in the art and such as detailed in Example 3 below.

K. thermotolerans as a pure culture did not complete the alcoholic fermentation during the experiment. The cells grew exponentially for 2 days, before entering the stationary growth phase. No death phase appeared in this experiment.

Conclusion of Single Strain Fermentations (Experimental Series I and II).

Saccharomyces cerevisiae was the only strain that was able to convert Pinot noir grape juice and Chardonnay grape juice into wine. Additionally, the experiments show that Torulaspora delbrueckii and Kluyveromyces thermotolerans are unable to convert the available glucose and fructose in either grape juices, thereby showing an incomplete fermentation which is not desired by wine producer.

This gives strong indications that the use of Torulaspora delbrueckii and Kluyveromyces thermotolerans as single strain yeast starter cultures is not desirable in neither white wine nor red wine fermentations, due to the risk of stuck alcoholic fermentation and/or development of off-flavours and off-aromas from the indigeneous yeast and bacteria flora.

### EXPERIMENTAL SERIES III

FIG. 7 illustrates an alcoholic fermentation by a mixed culture of Saccharomyces cerevisia and Torulaspora delbrueckii of Pinot noir grape juice (pasteurised at 140° C./284° F. in 8 seconds and stored in 5 litre sterile plastic containers at 5° C./39.2° F. until use) in a laboratory experiment in 3 litre scale incubated at 28° C./82.4° F. S. cerevisiae and Torulaspora delbrueckii were prepared by fluid bed drying as generally known in the art and such as detailed in Example 2 below and rehydrated as generally known in the art and such as detailed in Example 3 below.

The 1:1 mixture of S. cerevisiae and T. delbrueckii completed the alcoholic fermentation in 3 days. The cell number of S. cerevisiae and T. delbrueckii, respectively, increased rapidly until day 2, where S. cerevisiae entered stationary growth phase until day 3, where the cells entered the death phase. The cells of T. delbrueckii were strongly affected by the growth of S. cerevisiae, and hardly grew before entering stationary growth phase, and eventually the death phase.

FIG. 8 illustrates an alcoholic fermentation by a mixed culture of Saccharomyces cerevisiae and Kluyveromyces thermotolerans of Pinot noir grape juice (pasteurised at 140° C./284° F. in 8 seconds and stored in 5 litre sterile plastic containers at 5° C./39.2° F. until use) in a laboratory experiment in 3 litre scale incubated at 28° C./82.4° F. Saccharomyces cerevisiae and Kluyveromyces thermotolerans were prepared by fluid bed drying as generally known in the art and such as detailed in Example 2 below and rehydrated as generally known in the art and such as detailed in Example 3 below.

The 1:1 mixture of Saccharomyces cerevisiae and Kluyveromyces thermotolerans completed the alcoholic fermentation in 3 days. The cell number of Saccharomyces cerevisiae was affected by the presence of K. thermotolerans, and grew slower before reaching stationary phase at day 2, and entered the death phase shortly thereafter.

### EXPERIMENTAL SERIES IV

FIG. 9 illustrates an alcoholic fermentation by a mixed culture of Saccharomyces cerevisiae and Torulaspora delbrueckii of Chardonnay grape juice (pasteurised at 140° C./284° F. in 8 seconds and stored in 5 litre sterile plastic containers at 5° C./39.2° F. until use) in a laboratory experiment in 1 litre scale incubated at 20° C./68° F. Saccharomyces cerevisiae and Torulaspora delbrueckii were prepared by spray/fluid bed drying as generally known in the art and such as detailed in Example 2 below and rehydrated as generally known in the art and such as detailed in Example 3 below.

The 1:1 mixture of Saccharomyces cerevisiae and T. delbrueckii completed the alcoholic fermentation in 9 days. The cell number of Saccharomyces cerevisiae grew exponentially until day 3, before entering the stationary growth phase. The cells of T. delbrueckii grew exponentially until day 2, before rapidly entering the death phase.

FIG. 10 illustrates an alcoholic fermentation by a mixed culture of Saccharomyces cerevisiae and Kluyveromyces thermotolerans of Chardonnay grape juice (pasteurised at 140° C./284° F. in 8 seconds and stored in 5 litre sterile plastic containers at 5° C./39.2° F. until use) in a laboratory experiment in 1 litre scale incubated at 20° C./68° F. Saccharomyces cerevisiae and Kluyveromyces thermotolerans were prepared by spray/fluid bed drying as generally known in the art and such as detailed in Example 2 below and rehydrated as generally known in the art and such as detailed in Example 3 below.

The 1:1 mixture of Saccharomyces cerevisiae and Kluyveromyces thermotolerans completed the alcoholic fermentation in 9 days. The cell number of Saccharomyces cerevisiae grew exponentially until day 4, before entering the stationary growth phase. The cells of Kluyveromyces thermotolerans grew exponentially until day 2, before rapidly entering the death phase.

Conclusion of Mixed Culture Fermentations (Experimental Series III and IV).

Saccharomyces cerevisiae in combination with either Torulaspora delbrueckii or Kluyveromyces thermotolerans as mixed starter cultures, showed that Saccharomyces cerevisiae is the main driving force in the alcohol fermentation. Both Torulaspora delbrueckii and Kluyveromyces thermotolerans only grew to a limited extent before entering death phase. However, this relatively short period of active growth, is sufficient to modify the aroma and flavour compounds of the finished wine, as shown in tables 1 and 2.

Tables

The tables illustrate, but are not limited to, the aroma and flavour compounds produced by a mixture of Saccharomyces cerevisiae and Torulaspora delbrueckii or a mixture of Saccharomyces cerevisiae and Kluyveromyces thermotolerans. The tables illustrate the unexpected finding that the use of mixed yeast starter cultures of Saccharomyces cerevisiae and Torulaspora delbrueckii or of Saccharomyces cerevisiae and Kluyveromyces thermotolerans or any combinations thereof gives rise to the development of enhanced aroma and flavour profiles, which are different from those resulting from a pure strain fermentation of S. cerevisiae. In addition, the tables show aroma and flavour differences between the use of Saccharomyces/Torulaspora delbrueckii and Saccharomyces/Kluyveromyces thermotolerans.

TABLE 1

| Chemical compound | |
|---|---|
| (GC-olfactometry) | NIF detection |
| 3-methyl butyl acetate | Fruit |
| Ethyl hexanoat | Fruit, peach, pineapple |
| Hexyl acetate | Flowers, mild fruit |
| Cis-3-hexenyl acetate | Vitamin pill |
| n-octyl acetate | Sweet fruit, citrus |

Table 1 illustrates some of the chemical aroma components produced during alcoholic fermentation of Chardonnay grape juice (pasteurised at 140° C./284° F. in 8 seconds and stored in 5 litre sterile plastic containers at 5° C./39.2° F. until use) by a mixed culture of Saccharomyces cerevisiae and Torulaspora delbrueckii, not related to the grape juice nor a pure strain alcoholic fermentation by Saccharomyces cerevisiae under the same conditions. The experiment was conducted in 20 litre scale incubated at 20° C./68° F. The samples were analysed by GC-mass spectrometry (Williams, D. H. & Fleming, I., 1995) and NIF (Pollien et al., 1997)

Table 2 illustrates some of the chemical aroma components produced during alcoholic fermentation of Chardonnay grape juice by a mixed culture of Saccharomyces cerevisiae and Kluyveromyces thermotolerans not related to the grape juice nor a pure strain alcoholic fermentation by Saccharomyces cerevisiae under the same conditions. The experiment was conducted in 20 litre scale incubated at 20° C./68° F.

TABLE 2

| Chemical compound | |
|---|---|
| (GC-olfactometry) | NIF detection |
| 3-methyl butyl acetate | Fruit |
| Cis-3-hexenyl acetate | Vitamin pill |
| n-octyl acetate | Sweet fruit, citrus |
| Methyl octanoat | Hand soap, paper commercials |
| 2-methylbutyl octanoat | Citrus, fruit, flowers, sweet |
| ethyl nonanoat | Leather |
| ethyl decanoat | Hop, bad vitamin pill |
| Propyl decanoat | Citrus, Easter daffodil, pleasant |

A comparison of data from tables 1 and 2 strongly indicates that there are both similarities because of the presence of some of the same compounds, and differences in aroma components as a result of fermentation with T. delbrueckii/Saccharomyces cerevisiae compared to K. thermotolerans/Saccharomyces cerevisiae.

### DETAILED DESCRIPTION

Composition Comprising at Least One Non-Saccharomyces Yeast Organism

When the invention according to one aspect pertains to a composition comprising at least one first yeast organism selected from the family of Saccharomycetaceae excluding the genus of Saccharomyces, the at least one first yeast organism is in one embodiment selected from the genus of Torulaspora.

The Torulaspora organism is preferably selected from the group consisting of T. delbrueckii, T. alcoholi var alcoholi, T. alcoholi var. azymatica, T. amurcae, T. baili, T. benedictae, T. bispora, T. californica, T. carsonii, T. castellii, T. cidri, T. coudertii, T. etchellsii, T. eupagyca, T. exigua, T. fermentati, T. florentina, T. formicaria, T. fransiscae, T. globosa, T. hansenii, T. inconspicua, T. kloeckeriana, T. kluyveri, T. lactis a, T. manchuriana, T. melissophila, T. microellipsoides, T. mongolica, T. montana, T. mrakii, T. nilssonii, T. phaffii, T. polymorpha, T. pretoriensis, T. pseudopolymorpha, T. rosei, T. rouxii, T. tamarii, T. vafer, T. vanrijiae, T. yarrowii, including any combination thereof.

In another embodiment, the at least one first yeast organism is in one embodiment selected from the genus of Kluyveromyces. The Kluyveromyces organism is preferably selected from the group consisting of K. thermotolerans, K. subgenus Flabospora, K. subgenus Globospora, K. aestuarii, K. africanus, K. bacillisporus, K. blattae, K. bulgaricus, K. cellobiovorus, K. delphensis, K. dobzhanskii, K. drosophilarum, K. fragilis, K. lactis var, drosophilarum, K. lactis var. lactis, K. lodderae, K. marxianus var. bulgaricus, K. marxianus var. dobzhanskii, K. marxianus var. drosophilarum, K. marxianus var. lactis, K. marxianus var. marxianus, K. marxianus var. vanudenii, K. marxianus var. wikenji, K. nonfermentans, K. osmophilus, K. penaeid, K. phaffii, K. phaeseolosporus, K. piceae, K. polysporus, K. sinensis, K. vanudenii, K. veronae, K. waltii, K. wickerhamii, K. wikenii, and K. yarrowii, including any combination thereof.

The composition is preferably freeze dried or spray/fluid bed dried.

Composition Comprising at Least One First Non-Saccharomyces Yeast Organism and at Least One Second Non-Saccharomyces Yeast Organism

When the invention according to a second aspect pertains to a composition comprising at least one first yeast organism selected from the family of Saccharomycetaceae excluding the genus of Saccharomyces and at least one second yeast organism selected from the family of Saccharomycetaceae excluding the genus of Saccharomyces, the at least one first and second yeast organism is in one embodiment selected from the genus of Torulaspora and from the genus of Kluyveromyces, respectively.

The Torulaspora organism is preferably selected from the group consisting of T. delbrueckii, T. alcoholi var alcoholi, T. alkoholi var. azymatica, T. amurcae, T. bailii, T. benedictae, T. bispora, T. californica, T. carsonii, T. castellii, T. cidri, T. coudertii, T. etchellsii, T. eupagyca, T. exigua, T. fermentati, T. florentina, T. formicaria, T. fransiscae, T. globosa, T. hansenii, T. inconspicua, T. kloeckeriana, T. kluyveri, T. lactis a, T. manchuriana, T. melissophila, T. microellipsoides, T. mongolica, T. montana, T. mrakii, T. nilssonii, T. phaffii, T. polymorpha, T. pretoriensis, T. pseudopolymorpha, T. rosei, T. rouxii, T. tamarii, T. vafer, T. vanrijiae, T. yarrowii, including any combination thereof.

In combination with any of the above Torulaspora organisms, the Kluyveromyces organism is preferably selected from the group consisting of K. thermotolerans, K. subgenus Flabospora, K. subgenus Globospora, K. aestuarii, K. africanus, K. bacillisporus, K. blattae, K. bulgaricus, K. cellobiovorus, K. delphensis, K. dobzhanskii, K. drosophilarum, K. fragilis, K. lactis var, drosophilarum, K. lactis var. lactis, K. lodderae, K. marxianus var. bulgaricus, K. marxianus var. dobzhanskii, K. marxianus var. drosophilarum, K. marxianus var. lactis, K. marxianus var. marxianus, K. marxianus var. vanudenii, K. marxianus var. wikenii, K. nonfermentans, K. osmophilus, K. penaeid, K. phaffli, K. phaeseolosporus, K. piceae, K. polysporus, K. sinensis, K. vanudenii, K. veronae, K. waltii, K. wickerhamii, K. wikenii, K. yarrowii, including any combination thereof.

In one particularly preferred embodiment there is provided a composition, wherein the Torulaspora organism is Torulaspora delbrueckii and wherein the Kluyveromyces organism is Kluyveromyces thermotolerans.

The composition is preferably freeze dried or spray/fluid bed dried.

Composition Comprising One or More Non-Saccharomyces Yeast Organisms and at Least One Further Saccharomyces Yeast Organism

When the invention according to a third aspect relates to either a composition comprising at least one first yeast organism selected from the family of Saccharomycetaceae excluding the genus of Saccharomyces and at least one further yeast organism selected from the genus of Saccharomyces, or relates to a composition comprising at least one first yeast organism selected from the family of Saccharomycetaceae excluding the genus of Saccharomyces and at least one second yeast organism selected from the family of Saccharomycetaceae excluding the genus of Saccharomyces and at least one further yeast organism selected from the genus of Saccharomyces, the first and/or second (non-Saccharomyces) yeast organisms can be any of the (combinations of) organisms described herein above, whereas the at least one further yeast organism is preferably selected from the group consisting of Saccharomyces cerevisiae, Saccharomyces barnettii, Saccharomyces bayanus, Saccharomyces castellii, Saccharomyces dairenensis, Saccharomyces exiguus, Saccharomyces kluyveri, Saccharomyces paradoxus, Saccharomyces pastorianus, Saccharomyces rosinii, Saccharomyces servazzii, Saccharomyces spencerorum, Saccharomyces transvaalensis, and Saccharomyces Saccharomyces transvaalensis, and Saccharomyces unisporus, including any combination thereof.

Saccharomyces cerevisiae is preferred, optionally in combination with Torulaspora delbrueckii and Kluyveromyces thermotolerans.

The composition is preferably freeze dried or spray/fluid bed dried.

Colony Forming Units and Ratios Between Individual Yeast Organisms

When the above compositions are to be used as starter cultures it is desirable to have a number of colony forming units per gram (dry weight) starter culture which is preferably more than about 10⁸ CFU for the at least one further yeast organism, such as more than about 10⁹ CFU, for example more than about 10¹⁰ CFU, such as more than about 2×10¹⁰ CFU.

Likewise, it is desirable to have a number of colony forming units per gram (dry weight) starter culture which is preferably more than about 10⁷ CFU for the at least one first yeast organism and the same number of CFU for the at least one second yeast organism, when present, such as more than about 10⁸ CFU, for example more than about 10⁹ CFU, such as more than about 2×10⁹ CFU.

When the composition comprises the at least one first yeast organism and the at least one second yeast organism, the ratio R between i) the number (CFU) of the at least one first yeast organism cells, and ii) the number (CFU) of the at least one second yeast organism cells in the composition, is preferably in the range of from more than 0.1 to preferably less than 100, such as in the range of from 0.1 to 0.3, for example in the range of from 0.2 to 0.3, such as in the range of from 0.3 to 0.5, for example in the range of from 0.4 to 0.5, such as in the range of from 0.5 to 0.7, for example in the range of from 0.6 to 0.7, such as in the range of from 0.7 to 0.9, for example in the range of from 0.8 to 0.9, such as in the range of from 0.9 to 1.0 and such as about 1.0, for example in the range of from 1.0 to 1.1, such as in the range of from 1.1 to 1.3, for example in the range of from 1.2 to 1.3, such as in the range of from 1.3 to 1.5, for example in the range of from 1.4 to 1.5, such as in the range of from 1.6 to 1.8, for example in the range of from 1.7 to 1.8, such as in the range of from 1.8 to 2.0, for example in the range of from 1.9 to 2.0, such as in the range of from 2.0 to 2.4, for example in the range of from 2.2 to 2.4, such as in the range of from 2.4 to 3.0, for example in the range of from 2.8 to 3.0, such as in the range of from 3.0 to 4.0, for example in the range of from 3.5 to 4.0, such as in the range of from 4.0 to 5.0, for example in the range of from 4.5 to 5.0, such as in the range of from 5.0 to 7.0, for example in the range of from 6.0 to 7.0, such as in the range of from 7.0 to 9.0, for example in the range of from 8.0 to 9.0, such as in the range of from 9.0 to 12, for example in the range of from 10 to 12, such as in the range of from 12 to 16, for example in the range of from 14 to 16, such as in the range of from 16 to 20, for example in the range of from 18 to 20, such as in the range of from 20 to 30, for example in the range of from 25 to 30, such as in the range of from 30 to 50, for example in the range of from 40 to 50, and such as in the range of from 50 to 100.

When the composition comprises the at least one first yeast organism and the at least one further yeast organism the ratio R between i) the number (CFU) of the at least one first yeast organism cells, and ii) the number (CFU) of the at least one further yeast organism cells, is preferably in the range of from more than 0.1 to preferably less than 100, such as in the range of from 0.1 to 0.3, for example in the range of from 0.2 to 0.3, such as in the range of from 0.3 to 0.5, for example in the range of from 0.4 to 0.5, such as in the range of from 0.5 to 0.8, for example in the range of from 0.6 to 0.8, such as in the range of from 0.7 to 0.9, for example in the range of from 0.8 to 0.9, such as in the range of from 0.9 to 1.0 and such as about 1.0, for example in the range of from 1.0 to 1.1, such as in the range of from 1.1 to 1.3, for example in the range of from 1.2 to 1.3, such as in the range of from 1.3 to 1.5, for example in the range of from 1.4 to 1.5, such as in the range of from 1.6 to 1.8, for example in the range of from 1.7 to 1.8, such as in the range of from 1.8 to 2.0, for example in the range of from 1.9 to 2.0, such as in the range of from 2.0 to 2.4, for example in the range of from 2.2 to 2.4, such as in the range of from 2.4 to 3.0, for example in the range of from 2.8 to 3.0, such as in the range of from 3.0 to 4.0, for example in the range of from 3.5 to 4.0, such as in the range of from 4.0 to 5.0, for example in the range of from 4.5 to 5.0, such as in the range of from 5.0 to 7.0, for example in the range of from 6.0 to 7.0, such as in the range of from 7.0 to 9.0, for example in the range of from 8.0 to 9.0, such as in the range of from 9.0 to 12, for example in the range of from 10 to 12, such as in the range of from 12 to 16, for example in the range of from 14 to 16, such as in the range of from 16 to 20, for example in the range of from 18 to 20, such as in the range of from 20 to 30, for example in the range of from 25 to 30, such as in the range of from 30 to 50, for example in the range of from 40 to 50, and such as in the range of from 50 to 100.

When the composition comprises the at least one first and second yeast organism and the at least one further yeast organism, the ratio R between i) the number (CFU) of cells of the at least one first yeast organism and the at least one second yeast organism, and ii) the number (CFU) of the at least one further yeast organism cells, is preferably in the range of from more than 0.1 to preferably less than 100, such as in the range of from 0.1 to 0.3, for example in the range of from 0.2 to 0.3, such as in the range of from 0.3 to 0.5, for example in the range of from 0.4 to 0.5, such as in the range of from 0.5 to 0.8, for example in the range of from 0.6 to 0.8, such as in the range of from 0.7 to 0.9, for example in the range of from 0.8 to 0.9, such as in the range of from 0.9 to 1.0 and such as about 1.0, for example in the range of from 1.0 to 1.1, such as in the range of from 1.1 to 1.3, for example in the range of from 1.2 to 1.3, such as in the range of from 1.3 to 1.5, for example in the range of from 1.4 to 1.5, such as in the range of from 1.6 to 1.8, for example in the range of from 1.7 to 1.8, such as in the range of from 1.8 to 2.0, for example in the range of from 1.9 to 2.0, such as in the range of from 2.0 to 2.4, for example in the range of from 2.2 to 2.4, such as in the range of from 2.4 to 3.0, for example in the range of from 2.8 to 3.0, such as in the range of from 3.0 to 4.0, for example in the range of from 3.5 to 4.0, such as in the range of from 4.0 to 5.0, for example in the range of from 4.5 to 5.0, such as in the range of from 5.0 to 7.0, for example in the range of from 6.0 to 7.0, such as in the range of from 7.0 to 9.0, for example in the range of from 8.0 to 9.0, such as in the range of from 9.0 to 12, for example in the range of from 10 to 12, such as in the range of from 12 to 16, for example in the range of from 14 to 16, such as in the range of from 16 to 20, for example in the range of from 18 to 20, such as in the range of from 20 to 30, for example in the range of from 25 to 30, such as in the range of from 30 to 50, for example in the range of from 40 to 50, and such as in the range of from 50 to 100.

When the composition or yeast starter culture comprises a) Saccharomyces sp., including Saccharomyces cerevisiae, b) Torulaspora sp., including Torulaspora delbrueckii, and c) Kluyveromyces sp., including Kuyveromyces thermotolerans, the ratios (in colony forming units, CFU) among the aforementioned species a):b):c) is in one embodiment preferably about 1:1:1, such as about 1:1:2; for example 1:1:3, such as about 1:1:4; for example 1:1:5; such as about 1:2:1, for example 1:2:2; such as about 1:2:3, for example 1:2:4; such as about 1:2:5, for example 1:3:1; such as about 1:3:2, for example 1:3:3; such as about 1:3:4, for example 1:3:5; such as about 1:4:1, for example 1:4:2; such as about 1:4:3, for example 1:4:4; such as about 1:4:5, for example 1:5:1; such as about 1:5:2, for example 1:5:3; such as about 1:5:4, for example 1:5:5 and such as about 5:1:1 and such as about 5:1:2, for example 5:1:3; such as about 5:1:4, for example 5:1:5; such as about 5:2:1, for example 5:2:2; such as about 5:2:3, for example 5:2:4; such as about 5:2:5, for example 5:3:1; such as about 5:3:2, for example 5:3:3; such as about 5:3:4, for example 5:3:5; such as about 5:4:1, for example 5:4:2; such as about 5:4:3, for example 5:4:4; such as about 5:4:5, for example 5:5:1; such as about 5:5:2, for example 5:5:3; such as about 5:5:4, for example 10:1:1; such as about 10:1:2, for example 10:1:3; such as about 10:1:4, for example 10:1:5; such as about 10:2:1, such as about 10:2:3 and such as about 10:2:5, for example 10:3:1; such as about 10:3:2, for example 10:3:3; such as about 10:3:4, for example 10:3:5; such as about 10:4:1 and such as about 10:4:3 and such as about 10:4:5, for example 10:5:1; such as about 10:5:2, for example 10:5:3; such as about 10:5:4, for example 20:1:1; such as about 20:1:2, for example 20:1:3; such as about 20:1:4, for example 20:1:5; such as about 20:2:1 and such as about 20:2:3 and such as about 20:2:5, for example 20:3:1; such as about 20:3:2, for example 20:3:3; such as about 20:3:4, for example 20:3:5; such as about 20:4:1 and such as 20:4:3 and such as 20:4:5, for example 20:5:1; such as about 20:5:2, for example 20:5:3; such as about 20:5:4, for example 20:5:5 and for example 30:1:1; such as 30:1:2; for example 30:1:3; such as 30:1:4; for example 30:1:5; such as 30:2:1; for example 30:2:2; such as 30:2:3; for example 30:2:4; such as 30:2:5; for example 30:3:1; such as 30:3:2; such as about 30:3:4, for example 30:3:5; such as about 30:4:1, for example 30:4:2; such as about 30:4:3, for example 30:4:4; such as about 30:4:5, for example 30:5:1; such as about 30:5:2, for example 30:5:3; such as about 30:5:4, for example 30:5:5 and for example 40:1:1; such as about 40:1:2, for example 40:1:3; such as about 40:1:4, for example 40:1:5; such as about 40:2:1 and such as 40:2:3 and such as 40:2:5, for example 40:3:1; such as about 40:3:2, for example 40:3:3; such as about 40:3:4, for example 40:3:5; such as about 40:4:1 and such as about 40:4:3 and such as about 40:4:5, for example 40:5:1; such as about 40:5:2, for example 40:5:3; such as about 40:5:4, for example 40:5:5, such as about 50:1:1 and such as about 50:1:2, for example 50:1:3; such as about 50:1:4, for example 50:1:5; such as about 50:2:1, for example 50:2:2; such as about 50:2:3, for example 50:2:4; such as about 50:2:5, for example 50:3:1; such as about 50:3:2, for example 50:3:3; such as about 50:3:4, for example 50:3:5; such as about 50:4:1, for example 50:4:2; such as about 50:4:3, for example 50:4:4; such as about 50:4:5, for example 50:5:1; such as about 50:5:2, for example 50:5:3; such as about 50:5:4, for example 50:5:5.

Methods Relating to the Composition of the Invention

It is understood that the invention also relates to a method for fermenting at least one fermentable carbohydrate source in an aqueous composition. This method comprises the step of contacting the aqueous composition with the composition of the invention under conditions allowing said fermentation to occur, and in this case the carbohydrate source preferably comprises at least one pentose or at least one hexose, including any monomer, dimer, oligomer or polymer thereof. Preferred fermentable carbohydrate sources are e.g. fructose, glucose, galactose, maltose, sucrose, trehalose, melibiose, starch, raffinose, including any combination thereof. However, other carbohydrate sources can also be used.

When the aqueous composition comprises grape juice, the carbohydrate sources can be obtained from white grapes or red grapes, or both. The white grapes can be selected from the group of grapes consisting of Aligote, Chardonnay, Chenin Blanc, Columbard, Folle Blanche, Gewurztraminer, Groner Veltliner, Malvasia, Marsanne, Melon de Bourgogne, Muller-Thurgau, Muscadelle, Muscat, Palomino, Pedro Ximenez, Pinot Blanc, Pinot Gris/Pinot Grigio, Riesling, Rousanne, Sauvignon Blanc/Fume Blanc, Scheurebe, Semillion, Sylvaner, Trebbiano, Ugni Blanc, Verdicchio, Viognier, including any combination thereof.

The red grapes can be selected from the group of grapes consisting of Barbera, Brunello, Cabernet Franc, Cabernet Sauvignon, Carignana, Carmenere, Cinsault, Dolcetto, Dornfelder, Gamay, Grenache, Grignolino, Malbec, Merlot, Montepulciano, Mourvedre/Mataro, Nebbiolo, Petit Sirah, Petit Verdot, Pinotage, Pinot Meunier, Pinot Noir, Primitivo, Rondo, Sangiovese, Syrah/Shiraz, Tempranillo, Tinta Barroca, Tinta Cao, Toriga Francesa, Touriga Nacional, Tinta Roriz, Zinfandel, including any combination thereof.

As many wine districts have their own preferred combination of grapes, such combinations are also forming part of the invention. In some cases, wine can only be produced within a particular district when strict rules for grape combinations and quantities are adhered to. The skilled person will be familiar with such rules.

When the invention relates to a method for producing an edible or drinkable product, said method comprising the step of adding the composition according to the invention to a precursor composition of said product, fermenting said precursor composition and producing said edible or drinkable product, the product is in one embodiment an alcoholic beverage including wine, such as red wine, rose wine, blush wine, white wine, sparkling wine, and fruit wine. Further examples of alcoholic beverages comprise cider and beer. Examples of edible products comprise bread. Further examples of products are milk and soy.

In another embodiment, the invention relates to a method for flavouring an edible or drinkable product, said method comprising the step of adding the composition according to the invention to a precursor composition of said product, fermenting said precursor composition and flavouring said edible or drinkable product, preferably an alcoholic beverage such as e.g. wine, for example red wine, rose wine, blush wine, white wine, sparkling wine, and fruit wine, as well as cider and beer. The flavour can also be added to e.g. bread, milk and soy.

In another preferred embodiment, the invention relates to a method for preparing a dried composition according to the invention, said method comprising the steps of i) providing at least one first yeast organism, and ii) drying said at least one first yeast organism to produce a dried composition, preferably a freeze dried composition or a spray/fluid bed dried composition.

The method in one preferred embodiment comprises the steps of i) providing at least one first yeast organism selected from the genus of Torulaspora or the genus of Kluyveromyces, and ii) drying said composition, preferably by freeze drying or by spray/fluid bed drying. The first yeast organism is preferably Torulaspora delbrueckii or Kluyveromyces thermotolerans.

The method in another preferred embodiment comprises the steps of i) providing a composition comprising at least one first yeast organism selected from the genus of Torulaspora and at least one second yeast species selected from the genus of Kluyveromyces, and ii) drying said composition, preferably by freeze drying or by spray/fluid bed drying. The first yeast organism is preferably Torulaspora delbrueckii and the second yeast organism is preferably Kluyveromyces thermotolerans.

The method in yet another preferred embodiment comprises the steps of i) providing a composition comprising at least one first yeast organism selected from the genus of Torulaspora or the genus of Kluyveromyces, and at least one further yeast organism selected from the genus of Saccharomyces, and ii) drying said composition, preferably by freeze drying or by spray/fluid bed drying. The first yeast organism is preferably Torulaspora delbrueckii or Kluyveromyces thermotolerans, and the at least one further yeast organism is preferably Saccharomyces cerevisiae.

The method in an even further preferred embodiment comprises the steps of i) providing at least one first yeast organism selected from the genus of Torulaspora and at least one second yeast organism selected from the genus of Kluyveromyces and at least one further yeast organism selected from the genus of Saccharomyces, and ii) drying said composition, preferably by freeze drying or by spray/fluid bed drying. The first yeast organism is preferably Torulaspora delbrueckii, the second yeast organism is preferably Kluyveromyces thermotolerans. and the further yeast organism is preferably Saccharomyces cerevisiae.

In further embodiments there are provided the use of a composition according to the invention for the manufacture of a yeast starter culture for fermenting grape juice, including grape juice obtained from white grapes such as e.g. Aligote, Chardonnay, Chenin Blanc, Columbard, Folle Blanche, Gewurztraminer, Groner Veltliner, Malvasia, Marsanne, Melon de Bourgogne, Muller-Thurgau, Muscadelle, Muscat, Palomino, Pedro Ximenez, Pinot Blanc, Pinot Gris/Pinot Grigio, Riesling, Rousanne, Sauvignon Blanc/Fume Blanc, Scheurebe, Semillion, Sylvaner, Trebbiano, Ugni Blanc, Verdicchio, Viognier, including any combination thereof, as well as grape juice obtained from red grapes such as e.g. Barbera, Brunello, Cabernet Franc, Cabernet Sauvignon, Carignana, Carmenere, Cinsault, Dolcetto, Gamay, Grenache, Grignolino, Malbec, Merlot, Montepulciano, Mourvedre/Mataro, Nebbiolo, Petit Sirah, Petit Verdot, Pinotage, Pinot Meunier, Pinot Noir, Sangiovese, Syrah/Shiraz, Tempranillo, Tinta Barroca, Tinta Cao, Toriga Francesa, Touriga Nacional, Tinta Roriz, Zinfandel, including any combination thereof.

The invention also relates to the use of a composition according to the invention for producing an edible or drinkable product. In yet another embodiment there is provded the use of a composition according to the invention for flavouring an edible or drinkable product. The products include alcoholic beverages, including wine such as red wine, rose wine, blush wine, white wine, sparkling wine, fruit wine, as well as cider and beer. Additional products capable of being produced by the invention are bread, milk and soy.

There is also provided the use of at least one first yeast organism selected from the family of Saccharomycetaceae excluding the genus of Saccharomyces for the preparation of a yeast starter culture for fermenting grape juice and flavouring an edible or drinkable product resulting from said fermentation. The starter culture is preferably dried such as freeze dried or /fluid bed dried. The first yeast organism is preferably selected from the genus of Torulaspora, such as Torulaspora delbrueckii. However, the first species can also be selected from the genus of Kluyveromyces, including Kluyveromyces thermotolerans.

The starter culture is preferably dried by freeze drying or by spray/fluid bed drying when the present invention is used to provide a composition comprising at least one first yeast organism selected from the family of Saccharomycetaceae excluding the genus of Saccharomyces and at least one second yeast organism selected from the family of Saccharomycetaceae excluding the genus of Saccharomyces for the preparation of a yeast starter culture for fermenting grape juice and flavouring an edible or drinkable product resulting from said fermentation. The first yeast organism is preferably selected from the genus of Torulaspora, including Torulaspora delbrueckii, whereas the second yeast organism is preferably selected from the genus of Kluyveromyces, including Kluyveromyces thermotolerans.

The starter culture is preferably dried by freeze drying or by spray/fluid bed drying when the present invention is used to provide a composition comprising at least one first yeast organism selected from the family of Saccharomycetaceae excluding the genus of Saccharomyces and at least one further yeast organism selected from the genus of Saccharomyces for the preparation of a yeast starter culture for fermenting grape juice and flavouring an edible or drinkable product resulting from said fermentation. The first yeast organism is preferably selected from the genus of Torulaspora, such as Torulaspora delbrueckii. However, the first species can also be selected from the genus of Kluyveromyces, including Kluyveromyces thermotolerans. The further yeast organism is preferably Saccharomyces cerevisiae.

In yet another embodiment there is provided by the present invention the use of a composition comprising at least one first yeast organism selected from the family of Saccharomycetaceae excluding the genus of Saccharomyces and at least one second yeast organism selected from the family of Saccharomycetaceae excluding the genus of Saccharomyces and at least one further yeast organism selected from the genus of Saccharomyces for the preparation of a yeast starter culture for fermenting grape juice and flavouring an edible or drinkable product resulting from said fermentation.

The prepared starter culture is preferably dried, such as freeze dried or spray/fluid bed dried. The first yeast organism is preferably selected from the genus of Torulaspora, including Torulaspora delbrueckii, and the second yeast organism is preferably selected from the genus of Kluyveromyces, including Kluyveromyces thermotolerans. The further yeast organism is preferably Saccharomyces cerevisiae.

### EXAMPLES

The examples illustrate preferred embodiments of the invention without limiting the invention to such embodiments. In this context starter cultures is to be understood as inoculation material of the appropriate yeast strain for large-scale production.

### Example 1

Preparation of Starter Culture for Wine Fermentation by Means of Freeze Drying

The following examples illustrate the production and freeze drying of starter culture consisting of either Saccharomyces cerevisiae, or Torulaspora delbrueckii, or Kluyveromyces thermiotolerans.

Preparation of YPG growth medium. A mixture of 10 g/L D-Glucose, 5 g/L yeast extract, and 10 g/L peptone (YPG) adjusted to pH 5.5 adding 1N HCl before autoclavation at 121° C./249.8° F. for 20 minutes.

Preparation of YPG agar. A mixture of 10 g/L D-Glucose, 5 g/L yeast extract, 20 g/L agar, and 10 g/L peptone (YPG) adjusted to pH 5.5 adding 1 N HCl before autoclavation at 121° C./249.8° F. for 20 minutes. The liquid agar solution is dispersed in sterile petri dishes stored at 5° C. until use.

Preparation of inoculation material to be used as starter culture for large-scale production. This procedure is made up of 3 steps, before entering into a large scale tank.

Step 1. A pure culture ampoule containing the appropriate yeast species kept at −80° C./−112° F. is dispersed on an YPG agar plate and incubated for 48 hours at 30° C./86° F.

Step 2. From this YPG agar plate, a single colony of the appropriate yeast species is picked, and transferred to an YPG medium. The medium is incubated for 48 hours at 30° C./86° F. under shaking (200 rpm).

Step 3. This yeast solution is used for preparing a 1% starter culture in semi-large scale to fit an starter culture of 1% in the final large-scale. The 1% starter culture is prepared by diluting in a ratio of 1 to 100 the starter culture with the media used for the large scale production.

Large Scale Production

1% inoculation material prepared as described above, is inoculated into production tank containing YPG growth medium. Glucose being the carbohydrate source can be substituted by e.g. molasses or starch. The cells are incubated at 30° C./86° F. while being stirred at 200 rpm. The carbohydrate source is pumped into a tank while correlating with monitoring the optical density and air is pumped into tank while correlating with the ethanol production, i.e. if it is possible to measure the presence of any ethanol, more oxygen is to be pumped into the tank.

Inlets of air flow and carbohydrate are stopped after 16-18 hours. Cells are ready to be harvested after 24 hours.

The cells are harvested and concentrated approximately 15 times by centrifugation (e.g. 4000 rpm, 10 minutes). 1% glycerol is added as cryoprotective agent.

Freeze Drying

The concentrated cells are poured onto sterile trays and placed in a freeze dryer under vacuum. Water is evaporated from the cells monitored by weight loss during the drying. When the weight becomes constant, the product is dry, and is distributed to packing of sterile aluminium bags in various sizes as follows.

Freeze dried products of Saccharomyces cerevisiae and T. delbrueckii are mixed in a desired ratio as described on pp, in package sizes of e.g. 500 g, 1 kg, 5 kg, 25 kg. Freeze dried products of Saccharomyces cerevisiae and K thermotolerans are mixed in a desired ratio as described, in package sizes of e.g. 500 g, 1 kg, 5 kg, 25 kg.

Freeze dried products of Saccharomyces cerevisiae, T. delbrueckii and K. thermotolerans are mixed in a desired ratio as described, in package sizes of e.g. 500 g, 1 kg, 5 kg, 25 kg.

### Example 2

Preparation of Starter Culture by Means of Spray/Fluid Bed Drying

The following example illustrates the production and spray/fluid bed drying of Saccharomyces cerevisiae, Torulaspora delbrueckii, and Kluyveromyces thermotolerans.

Preparation of YPG growth medium. A mixture of 10 g/L D-Glucose, 5 g/L yeast extract, and 10 g/L peptone (YPG) adjusted to pH 5.5 adding 1 N HCl before autoclavation at 121° C./249.8° F. for 20 minutes.

Preparation of YPG agar. A mixture of 10 g/L D-Glucose, 5 g/L yeast extract, 20 g/L agar, and 10 g/L peptone (YPG) adjusted to pH 5.5 adding 1 N HCl before autoclavation at 121° C./249.8° F. for 20 minutes. The liquid agar solution is dispersed in sterile petri dishes stored at 5° C. until use.

Preparation of inoculation material to be used as starter culture for large-scale production. This procedure is made up of 3 steps, before entering into a large scale tank.

Step 1. A pure culture ampoule containing the appropriate yeast species kept at −80° C./−112° F. is dispersed on an YPG agar plate an incubated for 48 hours at 30° C./86° F.

Step 2. From this YPG agar plate, a single colony of the appropriate yeast species is picked, and transferred to an YPG medium. The medium is incubated for 48 hours at 30° C./86° F. under shaking (200 rpm).

Step 3. This yeast solution is used for preparing a 1% starter culture in semi-large scale to fit an starter culture of 1% in the final large-scale. The 1% starter culture is prepared by diluting in a ratio of 1 to 100 the starter culture with the media used for the large scale production.

Large Scale Production

1% inoculation material prepared as described above, is inoculated into production tank containing YPG growth medium. Glucose being the carbohydrate source can be substituted by e.g. molasses or starch. The cells are incubated at 30° C./86° F. while being stirred at 200 rpm. The carbohydrate source is pumped into a tank while correlating with monitoring the optical density and air is pumped into tank while correlating with the ethanol production, i.e. if ethanol is measured more oxygen is pumped into the tank.

Inlets of air flow and carbohydrate are stopped after 16-18 hours. Cells are ready to be harvested after 24 hours.

The cells are harvested and concentrated approximately 15 times by centrifugation (e.g. 4000 rpm, 10 minutes). 1% glycerol is added as cryoprotective agent.

Spray/Fluid Bed Drying

The concentrated cells is further up-concentrated in a fluid bed and thereafter pressed through an extruder or by spray drying directly into the dryer. The resulting yeast paste is then fed into a drying tower where the cells are dried. When the product is dry, it is distributed to packings of sterile aluminium bags in various sizes as follows.

Spray/fluid bed dried products of Saccharomyces cerevisiae and T. delbrueckii are mixed in a desired ratio as described on pp, in package sizes of e.g. 500 g, 1 kg, 5 kg, 25 kg.

Spray/fluid bed products of Saccharomyces cerevisiae and K. thermotolerans are mixed in a desired ratio as described on pp, in package sizes of e.g. 500 g, 1 kg, 5 kg, 25 kg.

Spray/fluid bed products of Saccharomyces cerevisiae, T. delbrueckii and K. thermotolerans are mixed in a desired ratio as described on pp, in package sizes of e.g. 500 g, 1 kg, 5 kg, 25 kg.

### Example 3

Fermentation of Grape Juice with a Mixture of 2 Yeast Genera

The following examples illustrate the preparation of an alcoholic fermentation by a mixed yeast starter culture, respectively.

3.1. Preparation of a Yeast Starter Culture of Saccharomyces cerevisiae and T. delbrueckii for Alcoholic Fermentation.

The recommended dosage is corresponding to a final concentration of yeast cells of 1-2×10⁶/ml.

A sealed pouch is opened containing the dried mixed yeast starter culture of Saccharomyces cerevisiae and T. delbrueckii.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae and T. delbrueckii. T. delbrueckii will only be active in the first part of the alcoholic fermentation until the oxygen is depleted. Saccharomyces cerevisiae will be active through the alcoholic fermentation and will be responsible for the completion of the alcoholic fermentation.

3.2. Preparation of a Yeast Starter Culture of Saccharomyces cerevisiae and K.thermotolerans for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae and K. thermotolerans.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae and K. thermotolerans. K. thermotolerans will only be active in the first part of the alcoholic fermentation until the oxygen is depleted. Saccharomyces cerevisiae will be active through the alcoholic fermentation and will be responsible for the completion of the alcoholic fermentation.

3.3. Preparation of a Yeast Starter Culture of Saccharomyces cerevisiae and Candida for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae and Candida.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae and Candida. Candida will only be active in the first part of the alcoholic fermentation until the oxygen is depleted. Saccharomyces cerevisiae will be active through the alcoholic fermentation and will be responsible for the completion of the alcoholic fermentation.

3.4. Preparation of a Yeast Starter Culture of Saccharomyces cerevisiae and DekkeralBrettannomyces for alcoholic fermentation.

The recommended dosage is corresponding to a final concentration of yeast cells of 1-2×10⁶/ml.

The sealed pouch is opened containing the dried mixed yeast starter culture of Saccharomyces cerevisiae and DekkeralBrettannomyces.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae and DekkeralBrettannomyces. DekkeralBrettannomyces will only be active in the first part of the alcoholic fermentation until the oxygen is depleted. Saccharomyces cerevisiae will be active through the alcoholic fermentation and will be responsible for the completion of the alcoholic fermentation.

3.5. Preparation of a Yeast Starter Culture of Saccharomyces cerevisiae and Pichia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae and Pichia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae and Pichia. Pichia will only be active in the first part of the alcoholic fermentation until the oxygen is depleted. Saccharomyces cerevisiae will be active through the alcoholic fermentation and will be responsible for the completion of the alcoholic fermentation.

3.6. Preparation of a Yeast Starter Culture of Saccharomyces cerevisiae and Metschnikowia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae and Metschnikowia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae and Metschnikowia. Metschnikowia will only be active in the first part of the alcoholic fermentation until the oxygen is depleted. Saccharomyces cerevisiae will be active through the alcoholic fermentation and will be responsible for the completion of the alcoholic fermentation.

### Example 4

Fermentation of Grape Juice with a Mixture of 3 Yeast Genera

The following examples illustrate the preparation of an alcoholic fermentation by a mixed yeast starter culture, respectively.

4.1. Preparation of a Yeast Starter Culture of Saccharomyces cerevisiae, T. delbrueckii and K. thermotolerans for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, T. delbrueckii and K. thermotolerans.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, T. delbrueckii and K. thermotolerans. T. delbrueckii and K. thermotolerans will only be active in the first part of the alcoholic fermentation until the oxygen is depleted. Saccharomyces cerevisiae will be active through the alcoholic fermentation and will be responsible for the completion of the alcoholic fermentation.

4.2. Preparation of a Yeast Starter Culture of Saccharomyces cerevisiae, K. thermotolerans and Candida for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, K. thermotolerans and Candida.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, K. thermotolerans and Candida. K. thermotolerans and Candida will only be active in the first part of the alcoholic fermentation until the oxygen is depleted. Saccharomyces cerevisiae will be active through the alcoholic fermentation and will be responsible for the completion of the alcoholic fermentation.

4.3. Preparation of a Yeast Starter Culture of Saccharomyces cerevisiae, K. thermotolerans and DekkeralBrettannomyces for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, K. thermotolerans and DekkeralBrettannomyces.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, K. thermotolerans and DekkeralBrettannomyces. K. thermotolerans and DekkeralBrettannomyces will only be active in the first part of the alcoholic fermentation until the oxygen is depleted. Saccharomyces cerevisiae will be active through the alcoholic fermentation and will be responsible for the completion of the alcoholic fermentation.

4.4. Preparation of a Yeast Starter Culture of Saccharomyces cerevisiae, K. thermotolerans and Pichia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, K. thermotolerans and Pichia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, K. thermotolerans and Pichia. K. thermotolerans and Pichia will only be active in the first part of the alcoholic fermentation until the oxygen is depleted. Saccharomyces cerevisiae will be active through the alcoholic fermentation and will be responsible for the completion of the alcoholic fermentation.

4.5. Preparation of a Yeast Starter Culture of Saccharomyces cerevisiae, K. thermotolerans and Metschnikowia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, K. thermotolerans and Metschnikowia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, K. thermotolerans and Metschnikowia. K. thermotolerans and Metschnikowia will only be active in the first part of the alcoholic fermentation until the oxygen is depleted. Saccharomyces cerevisiae will be active through the alcoholic fermentation and will be responsible for the completion of the alcoholic fermentation.

4.6. Preparation of a Yeast Starter Culture of Saccharomyces cerevisiae, Candida and DekkeralBrettannomyces for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, Candida and DekkeralBrettannomyces.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, Candida and DekkeralBrettannomyces. Candida and DekkeralBrettannomyces will only be active in the first part of the alcoholic fermentation until the oxygen is depleted. Saccharomyces cerevisiae will be active through the alcoholic fermentation and will be responsible for the completion of the alcoholic fermentation.

4.7. Preparation of a Yeast Starter Culture of Saccharomyces cerevisiae, Candida and Pichia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, Candida and Pichia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, Candida and Pichia. Candida and Pichia will only be active in the first part of the alcoholic fermentation until the oxygen is depleted. Saccharomyces cerevisiae will be active through the alcoholic fermentation and will be responsible for the completion of the alcoholic fermentation.

4.8. Preparation of a Yeast Starter Culture of Saccharomyces cerevisiae, Candida and Metschnikowla for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, Candida and Metschnikowia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, Candida and Metschnikowia. Candida and Metschnikowia will only be active in the first part of the alcoholic fermentation until the oxygen is depleted. Saccharomyces cerevisiae will be active through the alcoholic fermentation and will be responsible for the completion of the alcoholic fermentation.

4.9. Preparation of a Yeast Starter Culture of Saccharomyces cerevisiae, DekkeralBrettannomyces and Pichia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, DekkeralBrettannomyces and Pichia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, DekkeralBrettannomyces and Pichia. DekkeralBrettannomyces and Pichia will only be active in the first part of the alcoholic fermentation until the oxygen is depleted. Saccharomyces cerevisiae will be active through the alcoholic fermentation and will be responsible for the completion of the alcoholic fermentation.

4.10. Preparation of a Yeast Starter Culture of Saccharomyces cerevisiae, DekkeralBrettannomyces and Metschnikowia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, DekkeralBrettannomyces and Metschnikowia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, DekkeralBrettannomyces and Metschnikowia. DekkeralBrettannomyces and Metschnikowia will only be active in the first part of the alcoholic fermentation until the oxygen is depleted. Saccharomyces cerevisiae will be active through the alcoholic fermentation and will be responsible for the completion of the alcoholic fermentation.

4.11. Preparation of a Yeast Starter Culture of Saccharomyces cerevisiae, T. delbrueckii and Candida for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, T. delbrueckii and Candida.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, T. delbrueckii and Candida. T. delbrueckii and Candida will only be active in the first part of the alcoholic fermentation until the oxygen is depleted. Saccharomyces cerevisiae will be active through the alcoholic fermentation and will be responsible for the completion of the alcoholic fermentation.

4.12. Preparation of a Yeast Starter Culture of Saccharomyces cerevisiae, T. delbrueckii and DekkeralBrettannomyces for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, T. delbrueckii and DekkeralBrettannomyces.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, T. delbrueckii and DekkeralBrettannomyces. T. delbrueckii and DekkeralBrettannomyces will only be active in the first part of the alcoholic fermentation until the oxygen is depleted. Saccharomyces cerevisiae will be active through the alcoholic fermentation and will be responsible for the completion of the alcoholic fermentation.

4.13. Preparation of a Yeast Starter Culture of Saccharomyces cerevisiae, T. delbrueckii and Pichia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, T delbrueckii and Pichia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, T. delbrueckii and Pichia. T. delbrueckii and Pichia will only be active in the first part of the alcoholic fermentation until the oxygen is depleted. Saccharomyces cerevisiae will be active through the alcoholic fermentation and will be responsible for the completion of the alcoholic fermentation.

4.14. Preparation of a Yeast Starter Culture of Saccharomyces cerevisiae, T. delbrueckii and Metschnikowia for Alcoholic Fermentation.

The recommended dosage is corresponding to a final concentration of yeast cells of 1-2×10⁶/ml.

The sealed pouch is opened containing the dried mixed yeast starter culture of Saccharomyces cerevisiae, T. delbrueckii and Metschnikowia.

A dosage of 10-20 g/hl grape juice to be fermented is transferred into a mixture of ⅓ of grape juice and ⅔ of tap water preheated to 35° C./95° F. at mixed. Leave without stirring for 20 minutes, then homogenize properly, and add into the grape juice during pumping.

Fermentation

The carbohydrates in the grape juice are then fermented into end-fermentation product by Saccharomyces cerevisiae, T. delbrueckii and Metschnikowia. T. delbrueckii and Metschnikowia will only be active in the first part of the alcoholic fermentation until the oxygen is depleted. Saccharomyces cerevisiae will be active through the alcoholic fermentation and will be responsible for the completion of the alcoholic fermentation.

### REFERENCES

Bauer, F. F. & I. S. Pretorius. 2000. Yeast stress response and fermentation efficiency: How to survive the making of wine—A review. South African Journal of Enology and Viticulture 21: 27-51.

Hansen E. H., Nissen P., Sommer P., Nielsen J. C., Arneborg N. 2001. The effect of oxygen on the survival of non-Saccharomyces yeasts during mixed culture fermentations of grape juice with Saccharomyces cerevisiae. J. Applied Microbiology; 91: 541-547

Kurtzman, C. P. and J. W. Fell (editors). 1998. The yeasts, a taxonomic study. 4th ed., Elsevier, N.Y.

Pollien, P. et al., “Hyphenated headspace-gas chromatograhpy-sniffing technique: Screening or impact oderants and quantitative aromagram”, Journal of Agriculture and Food Chemistryl, 45:2630-2637, 1997

Williams, D. H. and Fleming, I., Mass Spectra I: Spectroscopic methods in organic chemistry, 5^{th} ed. , p.170, Shoppenhangers Road, Berkshire, England

1. A composition comprising at least one first yeast organism selected from the family of Saccharomycetaceae excluding the genus of Saccharomyces.

2. The composition according to claim 1 further comprising at least one second yeast organism selected from the family of Saccharomycetaceae excluding the genus of Saccharomyces.

3. The composition according to claim 1 further comprising at least one further yeast organism selected from the genus of Saccharomyces.

4. The composition according to claim 2 further comprising at least one further yeast organism selected from the genus of Saccharomyces.

5. (canceled)

6. (canceled)

7. The composition according to claim 1, wherein the composition is spray/fluid bed dried.

8. The composition according to claim 1, wherein the at least one first yeast organism is selected from the genus of Torulaspora.

9. (canceled)

10. The composition according to claim 8, wherein the Torulaspora organism is Torulaspora delbrueckii.

11. The composition according to claim 1, wherein the at least one first yeast organism is selected from the genus of Kluyveromyces.

12. (canceled)

13. The composition according to claim 11, wherein the Kluyveromyces organism is Kluyveromyces thermotolerans.

14. The composition according to claim 2, wherein the at least one first yeast organism is selected from the genus of Torulaspora and wherein the at least one second yeast organism is selected from the genus of Kluyveromyces.

15. (canceled)

16. The composition according to claim 14, wherein the Torulaspora organism is Torulaspora delbrueckii.

17. (canceled)

18. The composition according to claim 14, wherein the Kluyveromyces organism is Kluyveromyces thermotolerans.

19. The composition according to claim 14, wherein the Torulaspora organism is Torulaspora delbrueckii and wherein the Kluyveromyces organism is Kluyveromyces thermotolerans.

20. The composition according to claim 3, wherein the at least one further yeast organism is selected from the group consisting of Saccharomyces cerevisiae, Saccharomyces barnettii, Saccharomyces bayanus, Saccharomyces castellii, Saccharomyces dairenensis, Saccharomyces exiguus, Saccharomyces kluyveri, Saccharomyces paradoxus, Saccharomyces pastorianus, Saccharomyces rosinii, Saccharomyces servazzii, Saccharomyces spencerorum, Saccharomyces transvaalensis, and Saccharomyces unisporus and any combination thereof.

21. (canceled)

22. The composition according to claim 20, wherein the at least one first yeast organism is selected from the genus of Torulaspora.

23. (canceled)

24. The composition according to claim 22, wherein the Torulaspora organism is Torulaspora delbrueckii.

25. The composition according to claim 20, wherein the at least one first yeast organism is selected from the genus of Kluyveromyces.

26. (canceled)

27. The composition according to claim 25, wherein the Kluyveromyces organism is Kluyveromyces thermotolerans.

28. The composition according to claim 4, wherein the at least one further yeast organism is selected from the group consisting of Saccharomyces cerevisiae, Saccharomyces barnettii, Saccharomyces bayanus, Saccharomyces castellii, Saccharomyces dairenensis, Saccharomyces exiguus, Saccharomyces kluyveri, Saccharomyces paradoxus, Saccharomyces pastorianus, Saccharomyces rosinii, Saccharomyces servazzii, Saccharomyces spencerorum, .Saccharomyces transvaalensis, and Saccharomyces unisporus and any combination thereof.

29. The composition according to claim 28, wherein the at least one further yeast organism is Saccharomyces cerevisiae.

30. The composition according to claim 28, wherein the at least one first yeast organism is selected from the genus of Torulaspora and wherein the at least one second yeast organism is selected from the genus of Kluyveromyces.

31. (canceled)

32. The composition according to claim 30, wherein the Torulaspora organism is Torulaspora delbrueckii.

33. (canceled)

34. The composition according to claim 30, wherein the Kluyveromyces organism is Kluyveromyces thermotolerans.

35. The composition according to claim 30, wherein the Torulaspora organism is Torulaspora delbrueckii and wherein the Kluyveromyces organism is Kluyveromyces thermotolerans.

36. The composition according to any of claim 2, wherein the ratio R between i) the number of the at least one first yeast organism cells, and ii) the number of the at least one second yeast organism cells in the composition, is in the range of from more than 0.1 to less than 100.

37. The composition according to a claim 3, wherein the ratio R between i) the number of the at least one first yeast organism cells, and ii) the number of the at least one further yeast organism cells, is in the range of from more than 0.1 to less than 100.

38. The composition according to claim 4, wherein the ratio R between i) the number of cells of the at least one first yeast organism and the at least one second yeast organism, and ii) the number of the at least one further yeast organism cells, is in the range of from more than 0.1 to less than 100.

39. A method for fermenting at least one fermentable carbohydrate source in an aqueous composition, said method comprising the step of contacting the aqueous composition with the composition according to claim 1 under conditions allowing said fermentation to occur.

40. The method of claim 39, wherein the carbohydrate source comprises at least one pentose or at least one hexose, including any monomer, dimer, oligomer or polymer thereof.

41. The method of claim 39, wherein the fermentable carbohydrate source is selected from the group consisting of fructose, glucose, galactose, maltose, sucrose, trehalose, melibiose, starch, raffinose, and any combination thereof.

42. The method according to claim 39, wherein the aqueous composition comprises grape juice.

43. (canceled)

44. The method of claim 42, wherein the white grapes are selected from the group of grapes consisting of Aligoté, Chardonnay, Chenin Blanc, Columbard, Folle Blanche, Gewurztraminer, Grüner Veltliner, Malvasia, Marsanne, Melon de Bourgogne, Muller-Thurgau, Muscadelle, Muscat, Palomino, Pedro Ximénez, Pinot Blanc, Pinot Gris/Pinot Grigio, Riesling, Rousanne, Sauvignon Blanc/Fume Blanc, Scheurebe, Semillion, Sylvaner, Trebbiano, Ugni Blanc, Verdicchio, Viognier, and any combination thereof.

45. (canceled)

46. The method of claim 42, wherein the red grapes are selected from the group of grapes consisting of Barbera, Brunello, Cabernet Franc, Cabernet Sauvignon, Carignana, Carmenere, Cinsault, Dolcetto, Gamay, Grenache, Grignolino, Malbec, Merlot, Montepulciano, Mourvédre/Mataro, Nebbiolo, Petit Sirah, Petit Verdot, Pinotage, Pinot Meunier, Pinot Noir, Sangiovese, Syrah/Shiraz, Tempranillo, Tinta Barroca, Tinta Cao, Toriga Francesa, Touriga Nacional, Tinta Roriz, Zinfandel, and any combination thereof.

47. The method of claim 42, wherein the grape juice is obtained from at least one of the grapes according to claim 44 and at least one of the grapes according to claim 46.

48. A method for producing an edible or drinkable product, said method comprising adding the composition according to any of claim 1 to a precursor composition of said product, fermenting said precursor composition and producing said edible or drinkable product.

49. (canceled)

50. (canceled)

51. (canceled)

52. A method for flavouring an edible or drinkable product, said method comprising the step of adding the composition according to claim 1 to a precursor composition of said product, fermenting said precursor composition and flavouring said edible or drinkable product.

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. A method of producing a flavoured edible or drinkable product, comprising preparing a yeast starter culture which includes the composition of claim 1, adding the yeast starter culture to grape juice, fermenting the grape juice and flavouring an edible or drinkable product resulting from said fermentation.

97. (canceled)

98. (canceled)

99. (canceled)

100. (canceled)

101. (canceled)

102. (canceled)

103. (canceled)

104. A method of producing a flavored edible or drinkable product comprising preparing a yeast starter culture which includes the composition of claim 2, adding the yeast starter culture to grape juice, fermenting the grape juice and flavouring an edible or drinkable product resulting from said fermentation.

105. (canceled)

106. (canceled)

107. (canceled)

108. (canceled)

109. (canceled)

110. (canceled)

111. (canceled)

112. (canceled)

113. (canceled)

114. A method of producing a flavored edible or drinkable product comprising preparing a yeast starter culture which includes the composition of claim 3, adding the yeast starter culture to grape juice, fermenting the grape juice and flavouring an edible or drinkable product resulting from said fermentation.

115. (canceled)

116. (canceled)

117. (canceled)

118. (canceled)

119. (canceled)

120. (canceled)

121. (canceled)

122. (canceled)

123. A method of producing a flavored edible or drinkable product, comprising preparing a yeast starter culture, which includes the composition of claim 4, adding the yeast starter culture to grape juice, fermenting the grape juice and flavouring an edible or drinkable product resulting from said fermentation.

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. (canceled)
